(19) United States
(12) Patent Application Publication
(10) Pub. No.: US 2009/0250294 A1
(43) Pub. Date: Oct. 8, 2009

(54) Mount and Attachment System

(76) Inventor: Gary L. Byers, Columbia Falls, MT (US)

Correspondence Address: DOWREY RICKARDS, 19119 NORTHCREEK PARKWAY, SUITE 106, BOTHELL, WA, 98011, US

(21) Appl. No.: 12/226,937

(22) PCT Filed: May 1, 2007
(86) PCT No.: PCT/US07/10715

§ 371 Date: Oct. 31, 2008

Related U.S. Application Data
(60) Provisional application No. 60/797,168, filed on May 2, 2006.

(51) Int. Cl. E06C 7/14; B65D 51/00

(52) U.S. Cl. 182/129; 248/210; 220/200

(57) ABSTRACT

A system for mounting one of various demountable attachments on a ladder may comprise a mount having at least one post for receiving an attachment and a plurality of attachments, each having a receiver for the post of the mount.

### FIELD

The disclosure relates to demountable systems or kits for use in connection with ladders and other apparatus and structures.

### BACKGROUND

Persons desiring to support a variety of articles on a ladder, post, cart or the like may have multiple different tasks to perform. For example, a worker using a ladder may need to fasten wallboard to the interior wall framing with a power tool, where one type of ladder-mounted receptacle for his or her tools may be helpful, and may then wish to apply mud to the joints using another receptacle. Subsequently, the wall may be finished using paint or wallpaper, for which other receptacles may be helpful. While individual receptacles with integral means for mounting them on ladders may be purchased, this can be expensive and cumbersome, and may increase the amount of storage space required.

### BRIEF DESCRIPTION OF THE DRAWINGS

FIG. 1 is an isometric view of a system comprising a mount and various attachments and accessories useable therewith

FIG. 2 is an isometric view of a section of a ladder on which a mount and bucket attachment have been mounted.

FIG. 3 is an isometric view of a mount and universal mounting attachment.

FIG. 4 is an isometric view of the mount and attachment of FIG. 3 with the attachment mounted on the mount.

FIG. 5 is an isometric view of a mount and universal mounting attachment.

FIG. 6 is an isometric view of a mount on which a round bucket attachment is mounted.

FIG. 7 is an isometric view of a mount on which a rectangular bucket attachment is mounted.

FIG. 8 is an isometric view of a mount with a double bucket attachment.

FIG. 9 is an isometric view of a mount with a paint tray attachment.

FIG. 10 is an isometric view of a mount that includes a latch.

FIG. 10A is an isometric view of a mount that includes a latch with the latch in an open position.

FIG. 11 is an isometric view of the mount with latch of FIG. 10 on which a work tray is mounted.

FIG. 12 is an isometric view of the mount of FIG. 10 with a paint and work tray is a

FIG. 13 is an isometric view of the mount of FIG. 10 on which a rectangular bucket with a removable bail attached.

FIG. 14 is an isometric view of the bucket and mount of FIG. 13 with a bucket cover on the bucket.

FIG. 15 is an isometric view of the mount of FIG. 10 with a drywall pan mounted thereon and with a bail attached to the drywall pan.

FIG. 16 is an isometric view of a mount with the latch in its opened position and with a security catch extending upward beside the post.

FIG. 17 is an isometric view of the mount of FIG. 16 with opened latch, positioned on a section of a ladder.

FIG. 18 is a rear isometric view of the mount of FIG. 17 with a rectangular bucket demounted therefrom and with a view of the aperture through which the catch may be extended.

FIG. 19 is an isometric view of a mount 10 having dual catches 85 extending upward beside the post.

FIG. 20 is a rear isometric view of a mount having a fender extending across the back of the body, and showing “T”-shaped apertures for receiving “T”-shaped stabilizer pegs.

FIG. 21 is an isometric view of the front of a mount, the mount having two posts extending upwardly from the base and having a catch 85 extending upwardly between the two posts.

FIG. 22 is an isometric view of a mounting adapter and backing plate for use with a two-posted mount such as that shown in FIG. 21.

FIG. 23 is an isometric view of a mounting adapter for use with attachments having a curved mounting surface.

FIG. 24 is an isometric view of the rear side of a mount having a cam-lock stabilizing bar.

FIG. 25 is an isometric view of the mount of FIG. 24

FIG. 26 is a perspective view of the mount of FIGS. 24 and 25 with a strap extending across its rear side.

FIG. 27 is a perspective view of a rectangular bucket attachment with apertures about its periphery for holding tools and other objects.

FIG. 28 is an isometric view of a work tray attachment.

FIG. 29 is an isometric view of a paint tray attachment.

FIG. 30 is an isometric view of a bail.

FIG. 31 is an isometric view of a unitary mount system useable with ladders.

FIG. 32 is an isometric view of a holder attachment.

FIGS. 33 and 34 are perspective views of a two-post mount.

FIGS. 35 and 36 are perspective views of a mounting adapter having two pockets for receiving the posts of a two-post mount, and having a center channel for receiving a security catch.

FIGS. 37 and 38 are perspective views of a round bucket to which a mounting adapter has been affixed.

FIG. 39 is a perspective view of a wallboard tray with a mounting adapter attached thereto.

FIG. 40 is a perspective view of a paint tray attachment with a mounting adapter attached.

FIG. 41 is an isometric view of a system including a mount and attachments mountable thereon.

FIGS. 42 and 43 are isometric views of a more permanent mount.

FIGS. 44-46 are isometric views of a mount and backplate mounted on a railing formed of intersecting tubular members.

FIG. 47 is an isometric view of a paint tray with handle.

FIGS. 48 and 49 are isometric views of a paint tray with a removable handle.

FIG. 50 is an isometric view of a mount.

FIGS. 51 and 52 are left and right side elevations of the mount of FIG. 50.

FIG. 53 is an isometric view of a paint tray.

FIG. 54 is a top plan view of the paint tray of FIG. 53.

FIG. 55 is a front elevation of the paint tray of FIG. 53.

FIG. 56 is an isometric view of the paint tray of FIG. 53 with a bail mounted on the studs of the paint tray.

FIG. 57 is a front elevation of the paint tray with bail mounted thereon.

FIG. 58 is a isometric view of the paint tray of FIG. 53 with a cap mounted over the rear end thereof.

FIG. 59 is a right side elevation of the paint tray and cap of FIG. 58.

FIG. 60 is an isometric view of the cap of FIG. 58

FIG. 61 is a front elevational view of the cap of FIG. 60.

FIG. 62 is an isometric view of a rectangular bucket.

FIG. 63 is a top plan view of the bucket of FIG. 62.

FIG. 64 is an isometric view of the bucket of FIG. 62 with a bail mounted on the studs of the bucket.

FIG. 65 is an isometric view of a utility holder.

FIG. 66 is a bottom elevational view of the utility holder of FIG. 65.

### DETAILED DESCRIPTION

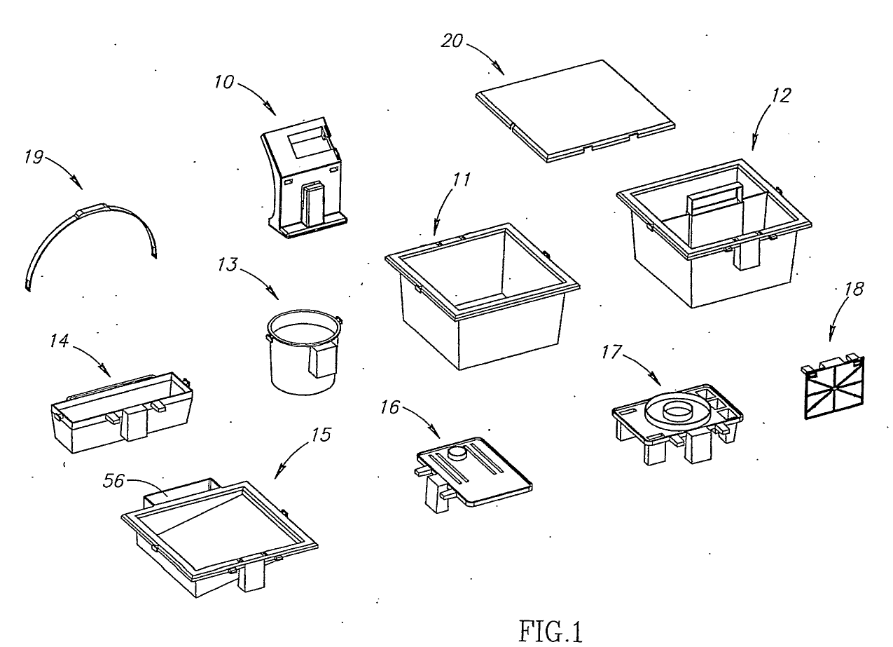

A system comprising a ladder mount and a variety of attachments mountable thereon may allow users of ladders and the like to perform multiple different tasks using a variety of different attachments in a convenient manner. As shown in FIG. 1, such a system may comprise a mount 10. The system may further comprise one or more attachments mountable on the mount such as a rectangular bucket 11, a double bucket 12, a round bucket 13, a drywall pan 14, a paint tray 15, a multi-purpose work tray 16, a multi-purpose paint and work tray 17, and/or a mounting adapter 18. Various accessories may also be provided, such as a removable bail 19 for various of the attachments, such as the buckets 11-13 and the drywall pan 14. A cover 20 may also be provided for various of the attachments. Although only one cover 20 is shown, covers of various dimensions and shapes may be provided as desired.

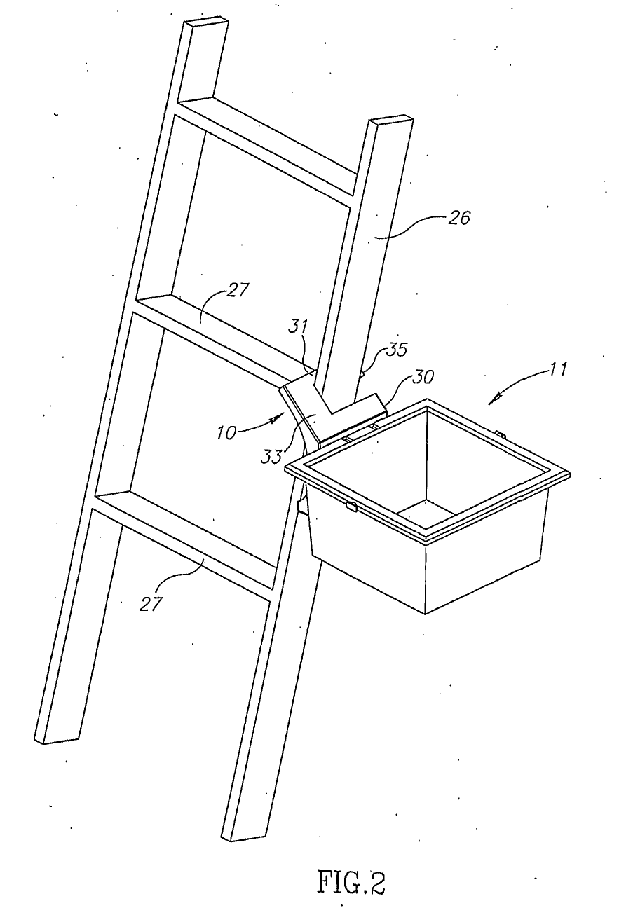

Referring next to FIG. 2, a mount 10 may be positioned on a ladder 25 by passing the arm 31 of the mount 10 behind the interior face of a leg 26 of the ladder 25 and allowing the body 30 of the mount 10 to rest against the exterior face of the leg 26. The arm 31 rests against a rung 27 of the ladder 25, and against the inside of the leg 26 against which the mount 10 rests.

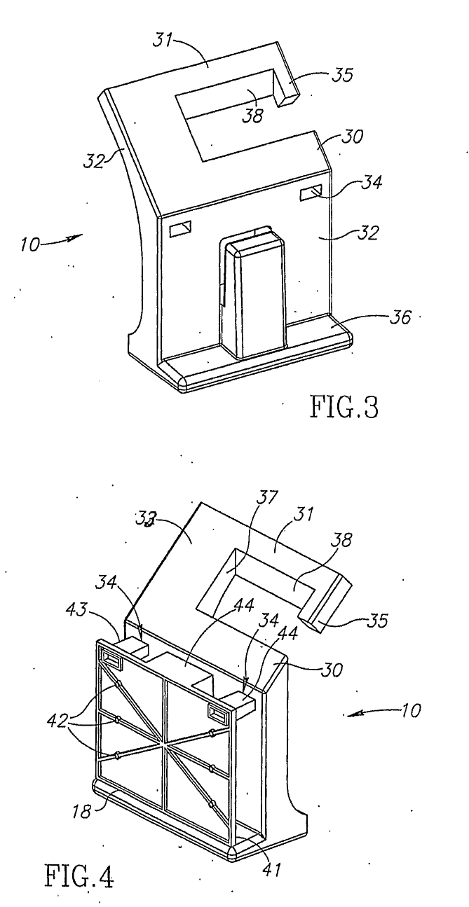

A mount 10, such as that shown in FIG. 3, may be made of a variety of materials such as, for example, plastics, reinforced plastics, metal and other suitable materials or combinations of materials, and may be formed by molding, casting, machining, bonding and other such methods.

The mount 10 according to this embodiment comprises a body 30 and arm 31 identified in FIG. 2. The mount 10 of this embodiment further comprises a post 32 supported by a base 36 that is supported by the body 30 of the mount 10. The post 32 extends upwardly and is spaced over at least a portion of its length from the adjacent surface of the body 30. The post 32 may be of any desired shape. In the present embodiment, the post 32 is of rectangular cross-section with rounded edges, and tapers toward its top so that a mating receiver (not shown in this figure) may be placed over it. The post 32 and the base 36, which provides the connection between the post 32 and the body 30 of the mount 10 may be of sufficient strength and rigidity, and may be so designed, to resist undue flexure when a load is being carried by the post 32.

The arm 31 is connected at one end to the body 30 by a support 33 that, in the present embodiment, extends upward and rearward of the body 30 of the mount 10. Referring to FIGS. 2-4, the inner, upwardly-extending surface of the support 33 may be formed to conform to the angle of the front surface of the adjacent leg 26 of a ladder 25. For example, an extension ladder may be placed against a vertical wall such that the angle formed between the ladder 25 and wall is about 30 degrees. In such case, if the corresponding inner surface 37 of the support 33 is similarly angled, it can more nearly lie flat against the front surface of the leg 26 of the ladder 25. The inner surface 38 of the arm 31 may likewise be angled so that, when the mount 10 is positioned on a ladder, the angle of the surface 38 approximates that of the inner surface of the leg 26. Referring to FIGS. 2-4, a retainer tab 35 extends a portion of the distance back from the distal end of the arm 31 toward the body 30 of the mount 10. The gap between the distal end of the tab 35 and the body 30 may be sufficient that the leg 26 of the ladder 25 may be passed through it in order to position the mount 10 on the ladder.

The support 33 and arm 31 and other parts of the mount 10 may also be formed from a material with sufficient strength and rigidity to resist undue flexure under the anticipated loads. In one embodiment, the mount 10, including all of its parts such as the arm 31, post 32, support 33 and body 30 may be made of molded polycarbonate resin.

In the present embodiment, the body 30 of the mount 10 includes two sockets 34, which may be used to receive stabilizing legs 44 extending from a utility attachment.

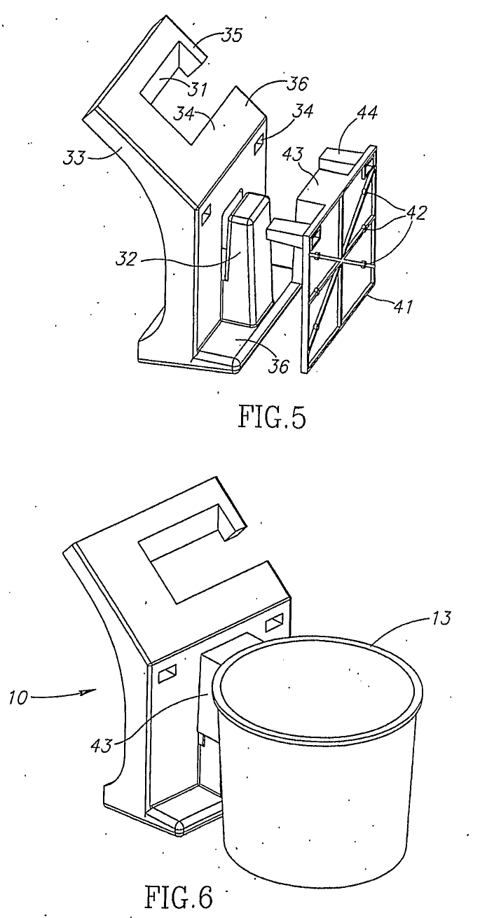

Referring in particular to FIGS. 4 and 5, a universal adapter attachment 18 of one embodiment may be mounted on the post 32 of the mount 10. The universal adapter 18 comprises an adapter body 41 to which any of a variety of articles may be fastened. A plurality of apertures 42 may be formed in the adapter body 41 of the universal adapter 18 so that screws, nuts and bolts, rivets, ties or other fasteners may be used to affix the adapter body 41 to the article. Such articles may be of any kind. For example, a tool box, tool holder, instrument case, spool holder, tape dispenser or the like may be fastened to the body 41 of the universal adapter 18.

In the present embodiment, a receiver 43 is connected to the rear surface of the adapter body 41, as by being molded integrally therewith. The sides and top of the receiver 43 form a pocket having internal dimensions and shape corresponding to that of the post 32 of the mount 10. The pocket of the receiver 43 may be of sufficient depth that, when the receiver 43 is mounted on the post 32, the top of the post 32 extends to the top of the pocket formed in the receiver 43, and the lower edges of the sides of the receiver 43 rest against the base 36 of the mount 10.

In the present embodiment, retainer comprising two legs 44 extend rearwardly from the adapter body 41 to releasably retain the adapter body 41 in a mounted position on a mount 10. The legs 44 are of sufficient length, and the distal ends of the legs 44 are of such shape and configuration that, when the post 32 of the mount 10 is completely inserted into the receiver 43 of the adapter plate 41, the ends of the legs extend into the sockets 34 in the body 30 of the mount 10. Some deflection of the post 32 relative to the body 30 of the mount 10 maybe required in order to achieve the insertion of the distal ends of the legs 44 into the sockets. mounted on the adapter body. The insertion of the legs 44 into the sockets 32 serves to resist accidental disengagement of the post 32 from the receiver 43, as well as to resist rotation of the adapter 18 in a vertical plane relative to the mount 10. The legs 44 may also aid in resisting pivoting of the receiver 43 relative to the post 32.

Referring to FIG. 6, according to another embodiment, an attachment comprising a round bucket 13 having a generally circular horizontal cross-section may include a receiver 43 to permit its mounting on the post 32 of the mount. Legs 44 such as those shown in FIGS. 4 and 5 could be formed on the receiver 43 or bucket 13, but in the present embodiment, no such legs 44 are present. As shown in FIG. 1, diametrically-opposed T-studs may be provided on the bucket 13 proximate to the rim so that a bail 19 may be attached to the bucket to facilitate carrying of the bucket.

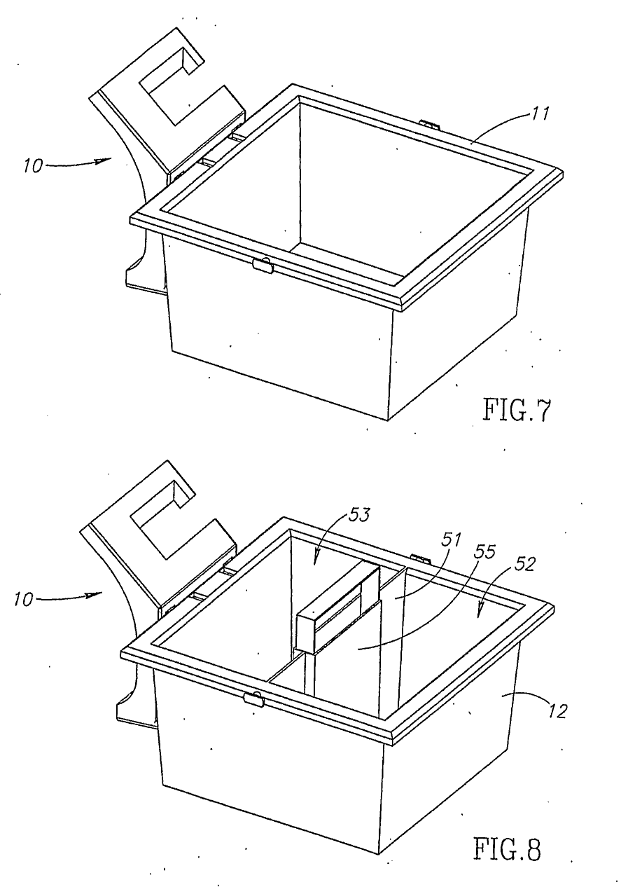

In another embodiment, as shown in FIG. 7, an attachment comprising a rectangular bucket 11 may be formed with a receiver 43 and legs 44 for mounting on the post 32 of a mount 10 in like manner to the mounting of the universal adapter 13 thereon. T-studs may also be provided on the rectangular bucket 11 so that a bail 19 may be used to carry it.

In another embodiment, as shown in FIG. 8, an attachment comprising a rectangular two-compartment bucket 12 may be formed with a receiver 43 and legs 44 for mounting on the post 32 of a mount 10 in like manner to the mounting of the universal adapter 13 thereon. T-studs may also be provided on the rectangular bucket 11 so that a bail 19 may be used to carry it. A wall 51 may be provided in the bucket 12 to separate the two compartments 52, 53 from one another. A carrying handle 54 may be attached to the wall or to a tower 55 that forms a part of the wall 51 to facilitate carrying of the bucket.

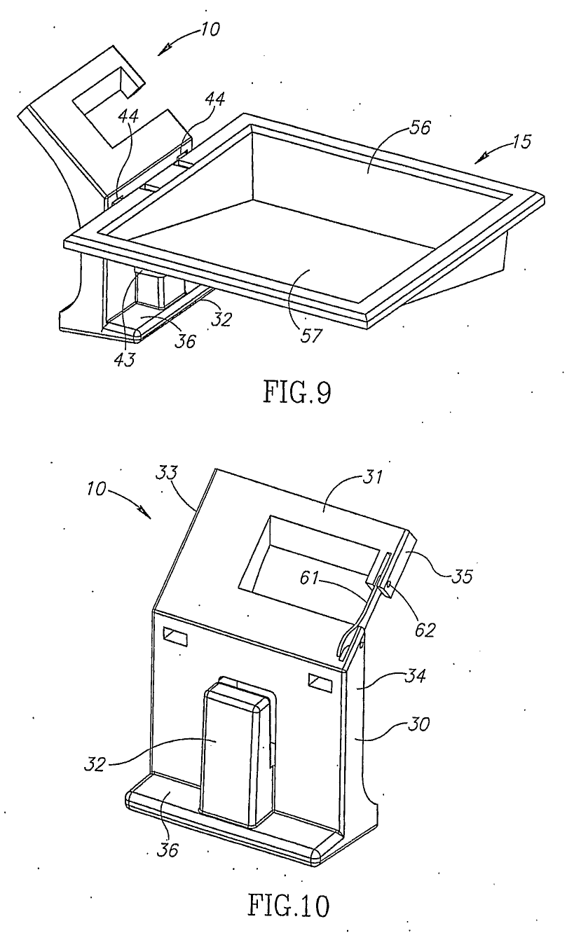

In another embodiment, as shown in FIG. 9, an attachment comprising a paint tray 15 may include a receiver 43 mountable on a post 32 of a mount 10. Legs 44 on the paint tray 15 may be inserted into sockets 34 in the body 30 of the mount 10 to provide added security and stability. The paint tray 15 may comprise a steeply sloped back portion 56 and a more gently sloping bottom portion to facilitate use of the paint tray 15 with a paint roller or the like. As shown in FIG. 1, a brush cup 56 may be mounted to one side of the paint tray to carry a paintbrush or other tool that may be used.

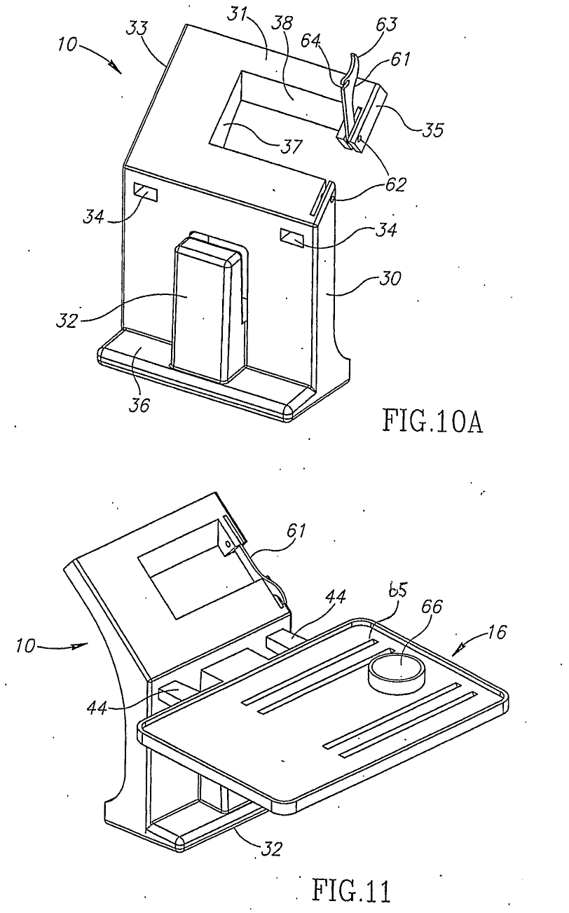

In another embodiment, as shown in FIGS. 10 and 10A, a modified mount 10 may include a slotted tab 35 in which a latch 61 may be pivotably mounted by a pin 62 extending through the slot. The distal end of the latch includes a channel 64 configured to snap around a second pin 62 extending across a corresponding slot formed in the body 30 of the mount 10. The latch 61 may be pivoted between an open position (as shown in FIG. 10A) in which the distal end of the latch 61 is remote from the body 30 to a closed position (as shown in FIG. 10) in which the channel in the distal end of the latch 61 snaps onto the pin 62 extending across the slot in the body 30 of the mount 10. A finger 63 extends from the top of the distal end of the latch 61 to facilitate release of the latch 61 from the pin 62 extending across the slot in the body 30 of the mount.

With the latch 61 in the open position, as shown in FIG. 1A, the mount 10 may be mounted on a ladder. Closing the latch 61, or using another form of keeper spanning the gap between the tab 35 and body 30, provides a complete encirclement of the leg 26 of the ladder 25 on which the mount 10 is mounted. The latch 61 thus provides a measure of security against the mount becoming accidentally disengaged from the ladder 25. The slots in the tab 35 and body 30 of the mount of the present embodiment may be cut, molded or otherwise formed in the tab 35 and body 30. The pins in the tab 35 and body 30 of the mount 10 may be molded in place or may be inserted through apertures formed in the tab 35 and body 30.

According to another embodiment, as shown in FIG. 11, an attachment comprising a work tray 16 may be mounted on the mount 10 shown in FIG. 10 (as well as that shown in FIG. 3). The tray includes elongated channels 65 for small items. For example, screws, nuts, nails, brads, drill bits, screwdriver bits, carpenter's pencils and the like might be placed in the channels. A drill or other tool or article may be carried by the tray by inserting a portion thereof in the cup 66 formed in the surface of the tray. The cup 66 may be formed without a bottom, so that elongated articles may be inserted therein. For example, the nose (chuck end) of a drill or the like may be inserted into the cup 66 for quick and easy access and security against the drill falling from the tray 16. Tools and other articles may be carried on the surface of the tray 16.

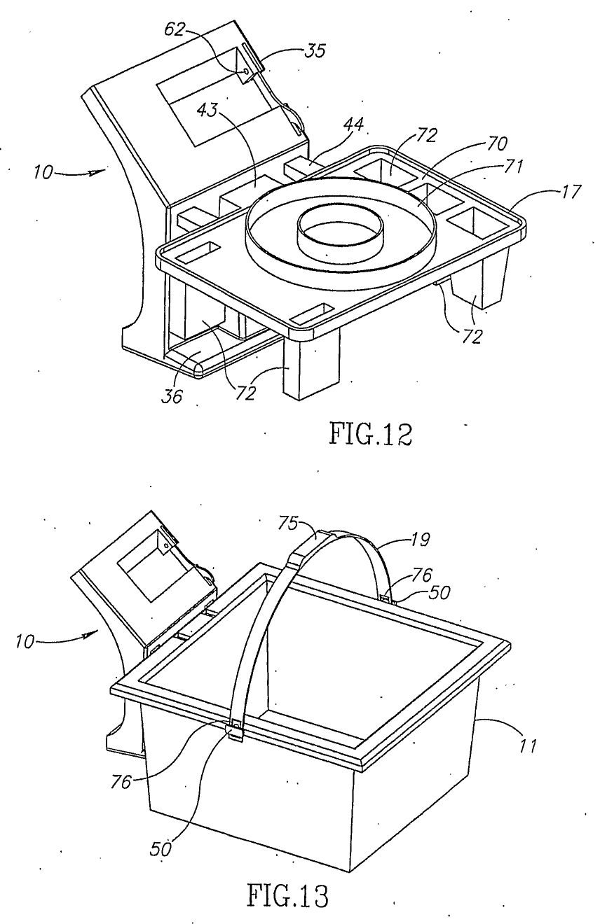

According to another embodiment, as shown in FIG. 12, an attachment comprising a paint and work tray 17 may be mounted on the mount 10 shown in FIG. 10 (as well as that shown in FIG. 3). Concentric rings 70, 71 have diameters generally corresponding to the diameters of standard paint cans (such as, for example, one and five gallon paint cans) or other such containers may fit therein. The outer ring 71 may extend to a height above the surface of the tray 17 that is greater than that of the inner ring 70. The rings 70, 71 may prevent a container placed therein from sliding laterally off the tray in the event it is bumped or the ladder 25 or mount 10 is caused to sway.

A plurality of cups 72 are provided about the periphery of the tray 17 for holding paint brushes, small articles, tools or the like. Small quantities of paint or other substance may also be contained by the cups 72. The cups 72 may be formed in the surface by molding or the like. In the absence of paint cans, the concentric rings 70, 71 may likewise serve to hold small articles or liquids. The bottoms of the cups 72 may serve as feet in the event the user of the tray 17 wishes to place the paint and work tray 17 on a planar surface.

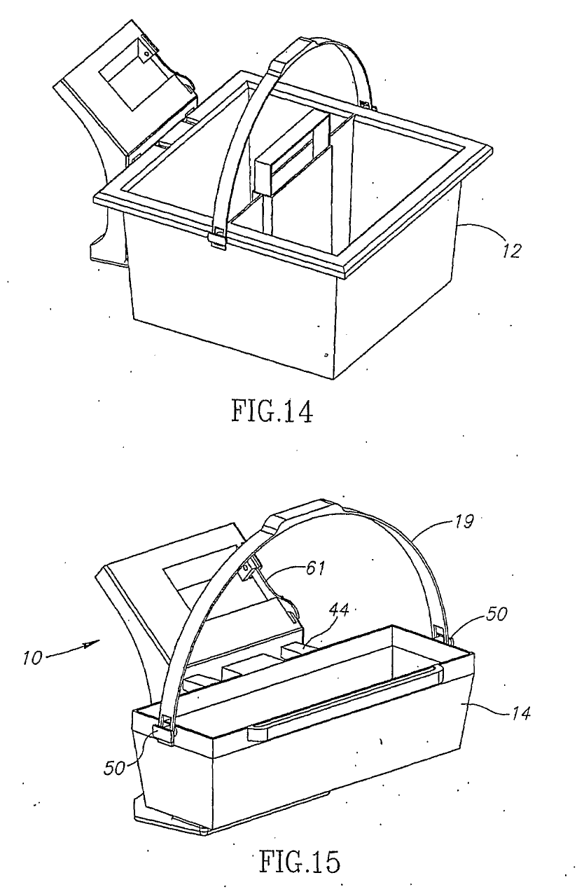

In yet other embodiments, FIGS. 13-15 show a rectangular bucket attachment 11, a two-compartment rectangular bucket attachment and a drywall pan attachment 14, respectively, mounted on a mount 10. A bail 19 may be attached to and may extend between T-studs 50 protruding from opposite sides of the buckets 11, 12 and drywall pan 14. The bail 19 may be flexible and may have handle portion 75 intermediate its ends that is of increased thickness so that it resists bending moreso than the thinner outer portions. Rectangular apertures 76 may have a length running generally parallel to the long axis of the bail 19 that, according to the present embodiment, it is greater than the width of the heads of the T-studs 50. The width of the apertures may be less than the width of the T-studs 50 along a horizontal line. When the bail 19 is lowered (as by pivoting about the axis of the shafts of the T-studs 50) so that the long axis of the aperture 76 is parallel to the width of the head of the T-stud 50, the head may be inserted through the aperture 76. Raising the bail 19 causes the apertures 76 to rotate so that their lengths extend generally vertically, making it difficult for the heads of the T-studs to pass back out of the apertures 76.

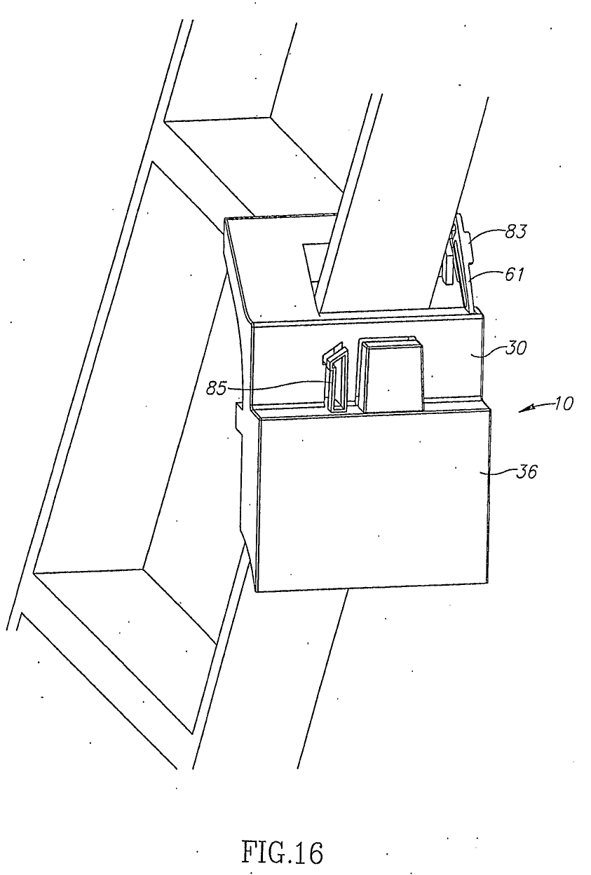

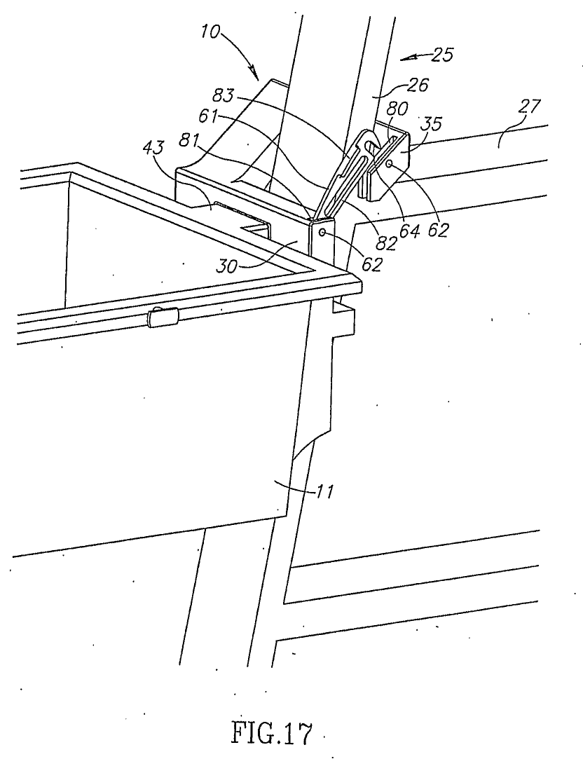

In another embodiment, as shown in FIGS. 16 and 17, the mount 10 has a keeper comprising a latch 61 of a different design from the latch of FIGS. 10 and 10A. As with the latching mechanism of FIGS. 10 and 10A, the latch 61 is attachable between the tab 35, which includes a slot 80 and the body 30 that includes a slot 81. The pivot end of the latch 61 is maintained in the slot 81 by a pin 62 that maybe inserted into an aperture in the body 30 of the mount 10, or that may be formed integrally therewith. A slot 82 may be formed to extend along the long axis of the latch 61. The pin 62 mounted in the body 30 of the mount 10 may be inserted through the slot 82 in the latch 61 so that the latch 61 may pivot about the pin 62. A tab 83 may be provided on the latch 61 extending laterally from the latch 61. The tab 83 may facilitate the unsnapping of the latch 61 from the pin 62 that extends through the slot 80.

The slot 81 may be of such a depth and length that, when the latch is fully raised, the latch may be pushed downward into the slot 81. The latch 61 may then be held in an upright position by the action of the pin 62, now located in the slot 81 intermediate the two ends of the latch 61, and the top of the latch bearing against the back of the slot 81. This may facilitate the positioning of the mount 10 on the ladder 25, as well as the removal of the mount 10 from the ladder, as the latch 61, in this position, is retained out of the way.

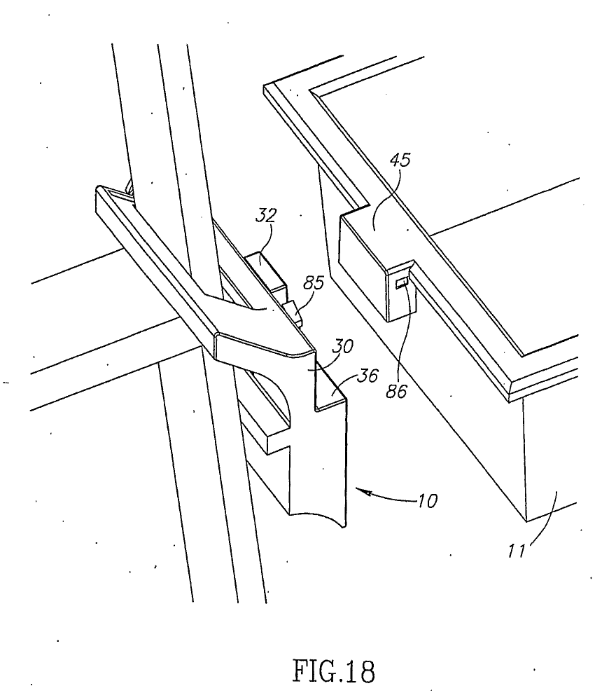

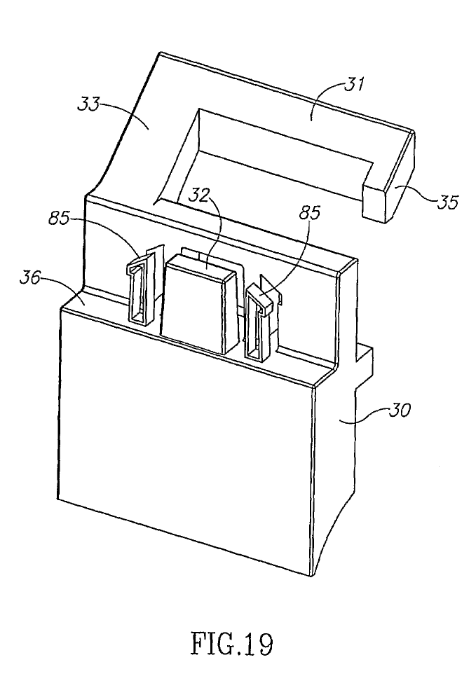

As shown in FIGS. 16-19, according to embodiments of the invention, one or more retainers or security catches 85 may extend upward from the base 36 generally in parallel with the post 32. Referring particularly to FIG. 18, the receiver 43 may form a first pocket for the post 32 and another pocket (or pockets) for the security latch 85 (or security latches 85, with reference to FIG. 19). An opening 86 may be provided in the wall of the other pocket of the receiver 43 that the security catch 85 can engage to retain the attachment 11 on the post 32 of the mount 10. The security catch or retainer 85 may be resilient and may be biased such that the tip thereof will seek to protrude through the opening 86 when the receiver 45 is mounted on the post 32 of the mount 10. Squeezing of the catch(es) 85 inward toward the receiver 43 pocket for the post 32 through the aperture(s) 86 may release the security catch(es) 85 from the receiver 43, allowing the removal of the attachment 11 from the post 32. The pocket formed by the receiver 43 for the post 32, of course, may have shape and dimensions to receive the post 32 with little or no play between the receiver 43 and the post 32.

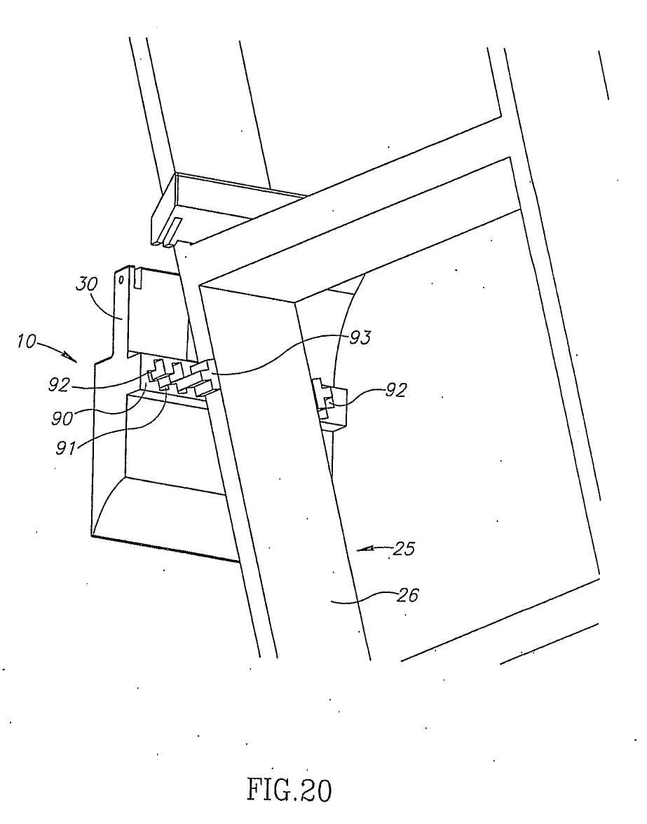

Referring to FIG. 20, in another embodiment, a fender 90 extends horizontally across the rear of the body 30 of the mount 10. The rear surface of the fender 90 includes a plurality of “T” slots 91. The stems 92 of the “T” slots 91 connect one “T” slot 91 to the next, so that a “T” peg 93 may be inserted with its stem 92 facing in either direction. The “T” slots 91 may be canted at an angle to the vertical so that the head thereof lies at an angle approximately equal to the angle from vertical of a properly positioned leg 26 of a ladder 25. A single “T” peg 93 may be positioned at either the front or rear of the leg 26 of the ladder 25 to provide stabilization to an attachment mounted on the mount 10, or “T” pegs 93 may be inserted on both sides of the ladder's 25 leg 26 for greater stabilization. Swinging or rocking of the attachment and mount 10 that may be occasioned, for example, during moving of the ladder, or, for example, when the attachment contains or supports a fluid that may slosh from side to side, such as in the case of a round or rectangular bucket 11, 13 that is partially filled with water.

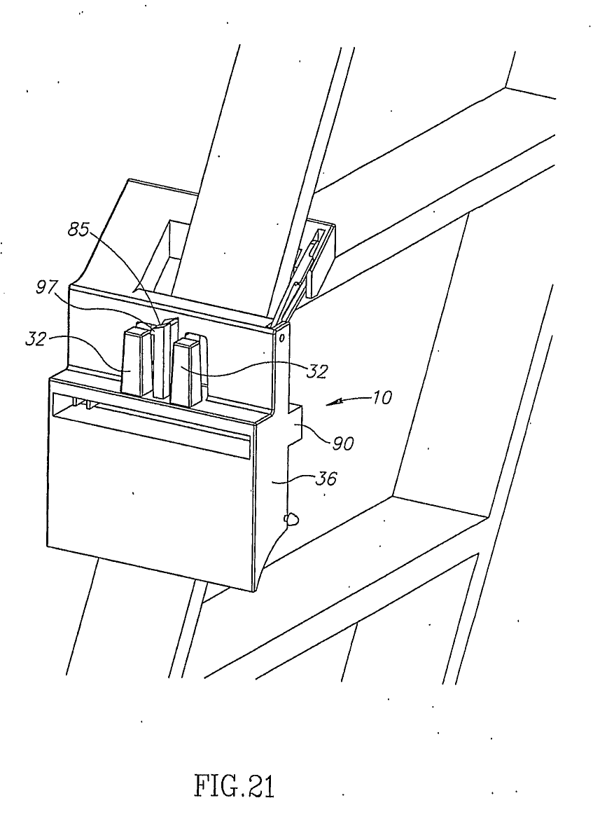

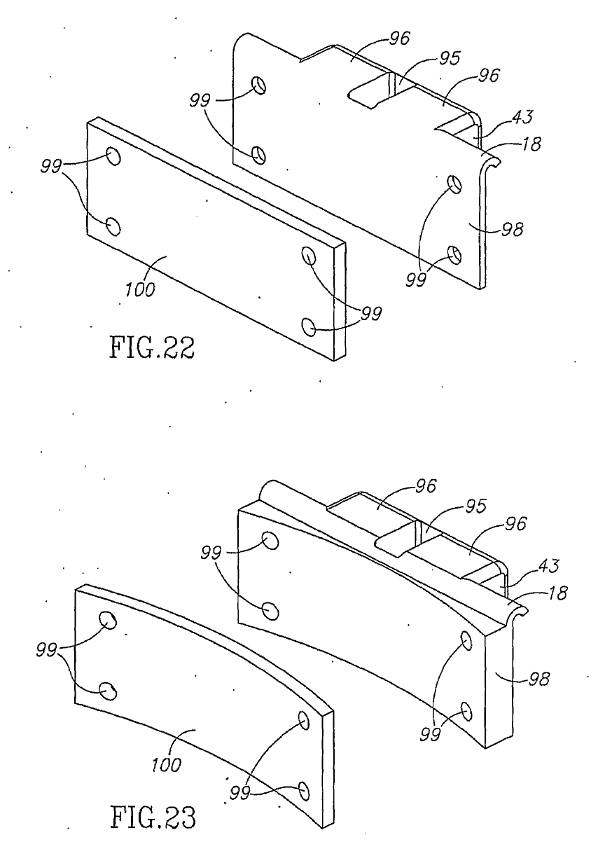

As shown in FIG. 21, in another embodiment, a mount 10 may have two posts 32 extending upwardly from the base 36. A security catch 85 may extend upward from the base 36 between the two posts 32 for securing an attachment on the mount. As with the other mounts 10, the receiver 43 may form a pocket for each of the posts 32 of the mount 10. For example, referring to FIGS. 22 and 23, a mounting adapter 18 of a different kind is shown. These mounting adapters 18 have receivers 43 in which a center channel 95 is provided. The catch 85 is extended up through this channel 95 and the hook 97 of the catch 85 snaps over the upper surface of the receiver 43 when the two posts 32 of the mount of FIG. 21 are inserted into pockets formed in the laterally-spaced portions 96 of the receiver 43. The pockets in the receivers 43 of the mounting adapters 18 shown in FIGS. 22 and 23, of course, may be formed to have shapes and dimensions corresponding to the shapes and dimensions of the two posts 32 that they are intended to receive.

Still referring to FIGS. 22 and 23, the two mounting adapters 18 permit a user to mount tool boxes, pails, equipment and other utility attachments that do not have receivers 43 on a mount. The adapters 18 may comprise a receiver 43 that receives the posts 32 and catch 85 of a mount 10, and may further comprise a fastening plate 98 that may be attached to the receiver 43 or, as shown, may be formed integrally therewith. The fastening plate 98 may include a number of fastener channels extending therethrough for use in fastening the mounting adapter 18 to a utility attachment. The fastening plates 98 of the mounting adapters 18 of FIGS. 21 and 22 differ from one another in that the fastening plate 98 of FIG. 21 is generally planar, while that of FIG. 22 is curved. The fastening plate 98 may be of any such configuration that is convenient for mounting on a utility item. The curved fastening plate 98 of the mounting adapter 18 of FIG. 23, for example, may be better suited for use with a round bucket, while a tool box with planar sides may be better suited for use with a mounting adapter 18 having a planar fastening plate 98, such as that of FIG. 22.

A plurality of fastener channels 99 may be provided in the fastening plates 98 for allowing the fastening of the mounting adapter 18 to a utility article by means of screws, rivets or the like. Any suitable means appropriate to the material of the mounting adapters 18, may be used to attach the mounting adapter to a utility attachment, such as, for example, adhesives, welding, screws, rivets, and nuts and bolts.

A backing plate 100 may be provided that has a curvature or other shape or configuration that corresponds to that of the mounting plate 98 or interior of the utility attachment. This backing plate 100 may have fastener channels 99 formed therein and disposed in a pattern corresponding to the pattern of the fastener channels 99 of the fastening plate of the adapter 18. Such a backing plate may distribute the load of the utility attachment over a broader area. For example, if the utility attachment is a round bucket made of a polyethylene or polypropylene material, the mounting adapter 18 of FIG. 23 may be used with the mounting adapter 18 placed on the outside of the bucket and the backing plate placed in the interior of the bucket with the fastener channels 99 of the mounting adapter 18 and backing plate 100 aligned with one another and with holes formed in the bucket. Bolts may then be passed through the fastener channels 99 and holes, and the assembly may be completed by threading nuts onto the screw threads of the bolts.

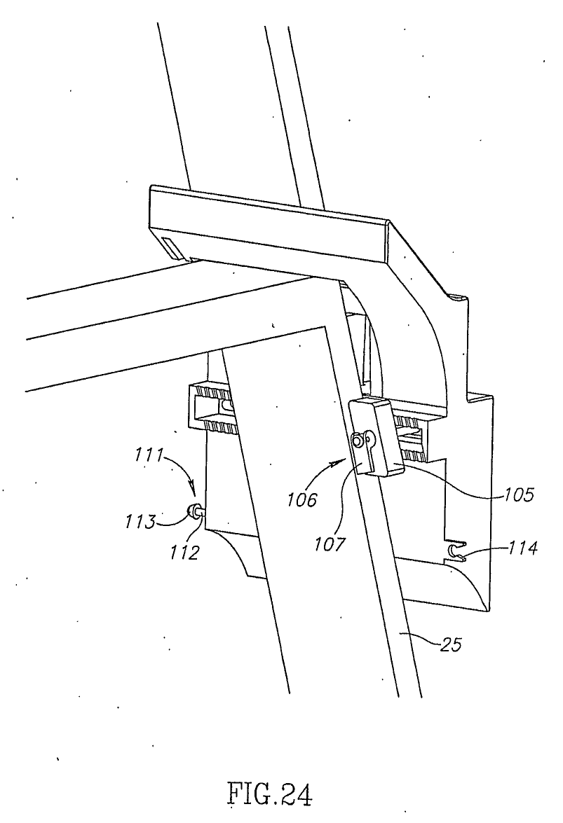

An alternative method of stabilizing a mount 10 is depicted in FIGS. 24 and 25. In this embodiment, a mount 10 may incorporate a fender 90 that may include a single slot 101 along its long axis. The surfaces 102 adjacent the slot 101 may be textured, such as by providing rows of teeth therealong. A stabilizer bar 105 having a corresponding, opposed surface may be mounted in contact with the surface 102 of the fender 90 by a bolt 108 extending through the slot 101 in the fender 90 that extends through an aperture in the stabilizer bar 105. The bolt 108 is retained in the bar by a cam-lock fastener 106 that threads onto the bolt 108, the arm 107 of which may be pivoted between a lock position, as shown, in which the action of the cam lock fastener 106 applies a force on the bolt 108 and stabilizer bar 105 to draw the stabilizer bar 105 tightly into engagement with the surfaces 102 of the fender 90 that extend along either side of the slot, and a release position, in which the force is relaxed and the stabilizer bar 105 is free to move laterally along the surface 102.

The surfaces 102 extending along the sides of the slot 101 may be toothed, as mentioned above, or may have other texturing, such as crenellations, vertical grooves and so forth. The adjacent surface of the stabilizing bar 105 may have corresponding texture to provide a more positive fixing in place of the position of the stabilizing bar 105 when the arm 107 of the cam-lock fastener is in the locked position. A second bolt 108, stabilizer bar 105 and cam-lock fastener could be provided for use on the other side of the leg 26 of the ladder 25, if desired.

The mount 10 of this embodiment may be further stabilized against swinging by use of a safety strap 110. According to one embodiment, a stud 111, comprising a shaft 112 and head 113 extends from one side of the body 30 of the mount 10. A hole 115 is provided in one end of the strap 110. The hole may be of sufficient size so that it may be stretched to pass over the head 113 of the stud 111 and be retained by the head 113 on the shaft 112. A keeper 114 extends from the body 30 of the mount 10 on the other side of the body 30. At least one knot, bead, thickening or stop 116 may be provided proximate to the free, distal end of the strap 110 so that when the strap 110 is extended behind the leg 26 of a ladder 25, the knot 116 may be lodged behind the keeper 114. In such a position, the strap acts on the leg 26 of the ladder 25 and on the mount 10 to urge them together. Multiple knots, beads or other stops 116 may be provided along the length of the strap 110 to permit adjustment of the tension of the strap 110 and/or to accommodate ladder legs 26 of different shapes and dimensions.

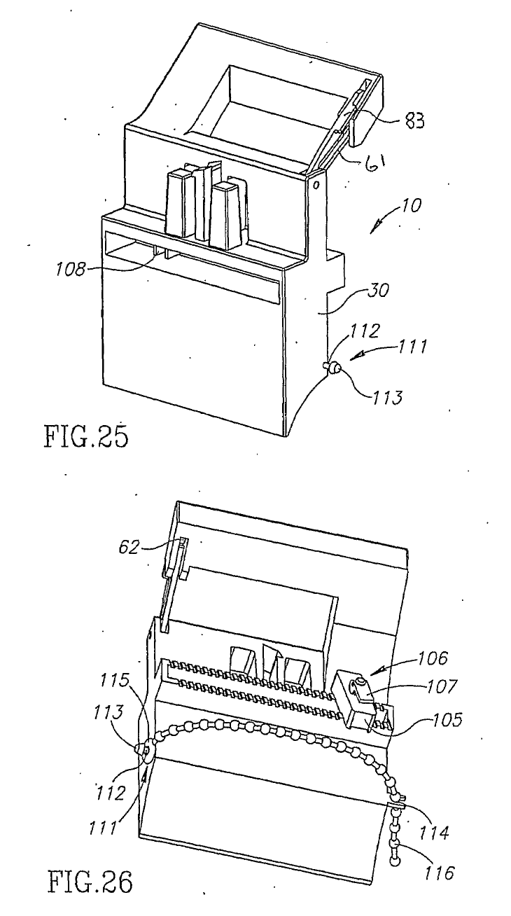

FIGS. 27-30 show a variety of embodiments of attachments mountable to a mount 10. As depicted, the receivers 43 of these attachments are designed to mate with a dual post mount 10 as shown in FIGS. 25-26. The receivers 43 are formed with a channel for the security catch that extends upward between the two posts 32 of the mount 10.

Referring to FIG. 27, a side-mount rectangular bucket 11 has lips 120 on either end. A plurality of apertures 121 are formed in the lips 120 for receiving tools and other articles, such as, for example, wrenches, screw drivers, brushes, caulking guns, scrapers and so forth. T-studs 50 extend outwardly from both ends of the rectangular bucket 11 beyond the lips 120 thereof. The heads of these studs 50 are round and are intended for use with a bail 19 that is described above and below. It should be noted that the top of the receiver of the bucket 11 of this embodiment is at a level with the upper edge of the bucket 11. A lid 20, designed to accommodate the positioning of the receiver, may include a portion that partially or wholly covers the receiver 43.

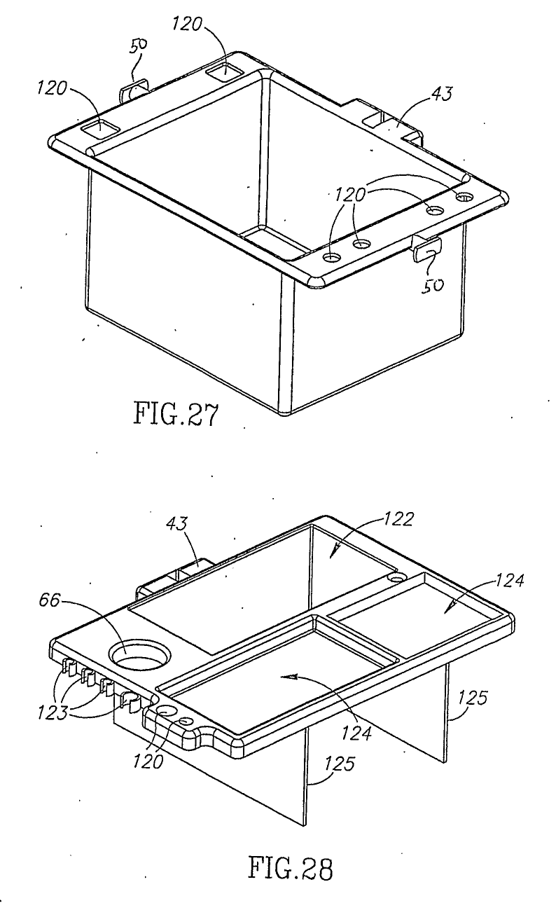

FIG. 28 shows a modified work tray 16 designed for use with cordless drills and the like. In this embodiment, as with the work tray 16, the nose of a drill may be inserted into the aperture 66 adjacent one edge of the tray 16. A rectangular recess 122 may be provided in the tray 16 to receive the battery pack commonly mounted beneath the grip of the current designs of cordless drills. Clips 123 may be provided along an edge of the tray 16 to permit the mounting of bits such as hexagonal screwdriver bits. Tools such as screwdrivers and so forth may be retained by apertures 120 in the upper surface of the tray 16 in like manner as described in connection with the apertures 120 in the bucket 11 of FIG. 27. Additional rectangular recesses 124 may be provided in the upper surface of the tray 16 to retain tools, fasteners, and other articles needed for the work to be accomplished. Legs 125 may depend from the tray 16 to permit it to be set on a level surface with the upper surface of the tray 16 remaining level despite the varying depth of the recesses 122, 124 and the like.

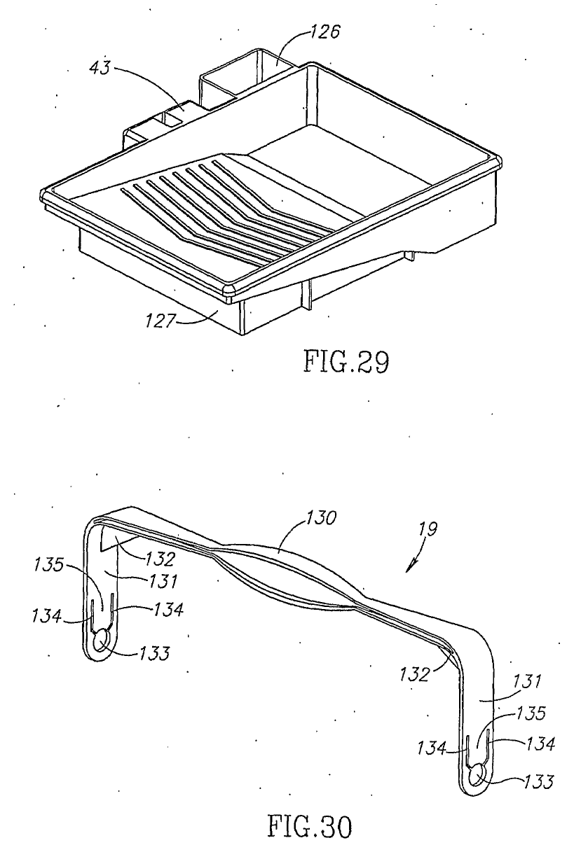

FIG. 29 shows another paint and work tray 17 that is adapted for use with the dual post mount 10. One or more brush cups 126 may be formed about the periphery of the paint tray 15 for holding tools such as, for example, brushes, rollers, scrapers, screw drivers and so forth. A skirt 127 may be provided adjacent the periphery to maintain the paint and work tray level when set on a flat surface.

Another embodiment of the bail 19 is depicted in FIG. 30. The bail 19 has a handle portion 130 that extends between two generally vertical end portions 131. As shown in FIG. 30, the handle portion is made more rigid by an I-beam type construction. Gussets 132 at the corners formed by the intersection of the handle portion 130 and end portions 131 aid in resisting deformation of the handle portion 130 and side portions 131 into the configuration that a simple strap would take.

Mounting holes 133 are provided adjacent the free ends of the end portions 131 of the bail. Channels 134 in the end portions 131 extend upward from either side of the holes. These channels permit the part 135 of the end portions 131 between the channels 134 and above the hole 133 to deform to allow the heads of round-headed studs 50 to be inserted through the bail 19. This part 135 may then return to its original configuration to retain the stud 50 in the hole 133.

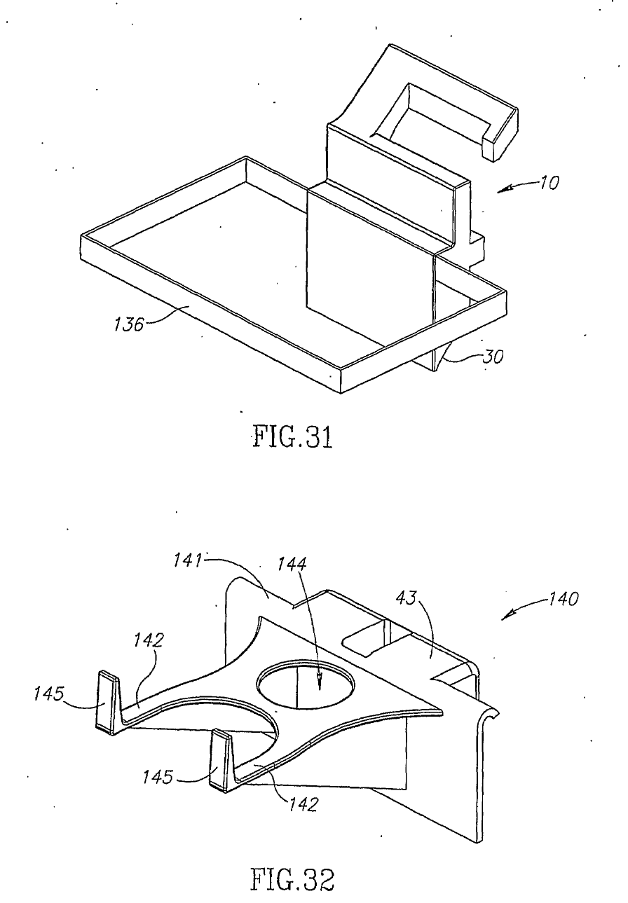

FIG. 31 depicts yet another embodiment in which a support band 137 is formed integrally with the body of a mount 10 without the use of a receiver 43 or posts. Articles such as tool boxes, tool trays, rectangular buckets and the like of corresponding dimensions may be inserted into the support band 136 to be held in position for use. The entire assembly may then be mounted on and demounted from a ladder 25.

FIG. 32 shows another embodiment of an attachment mountable on a mount 10. The utility holder 140 of this embodiment may comprise a receiver 43 from which a holder body 141 protrudes. The holder body 141 may comprise a pair of arms extending outwardly away from the receiver section and forming a “U”-shaped channel 143 between them. A hose mount aperture 144 may be formed between the “U”-shaped channel and the receiver. A pair of upwardly-extending retainers may extend upwardly from the free ends of the arms 142. The holder may be used for a variety of purposes. First, it is common to use a long-handled roller for painting, but such rollers typically retain a quantity of paint, so resting them on the floor in a paint tray leaves the handle extending across the floor. Rather than creating such a tripping and spillage hazard, the handle of the roller may be inserted into the “U”-shaped channel formed between the arms 142, and the end of the handle may be rested on the floor or ground. Other articles may be inserted in the “U”-shaped channel. For example, the handle of a claw-shaped hammer or putty knife may be inserted therein. The retainer tabs 145 at the ends of the arms 142 retain the tools against sliding outward past the ends of the arms 142. Similarly, the arms may be used for holding a coiled power cord. A hose may be passed upward through the hose aperture 144 in the holder body. A nozzle may then be attached to the hose. If the diameter of the hose aperture is smaller than the diameter of the nozzle, and less than the outside diameter of the hose, the nozzle may prevent the hose from slipping back out through the hose aperture 144 while allowing the nozzle to be drawn upward, pulling a portion of the hose through the hose aperture 144.

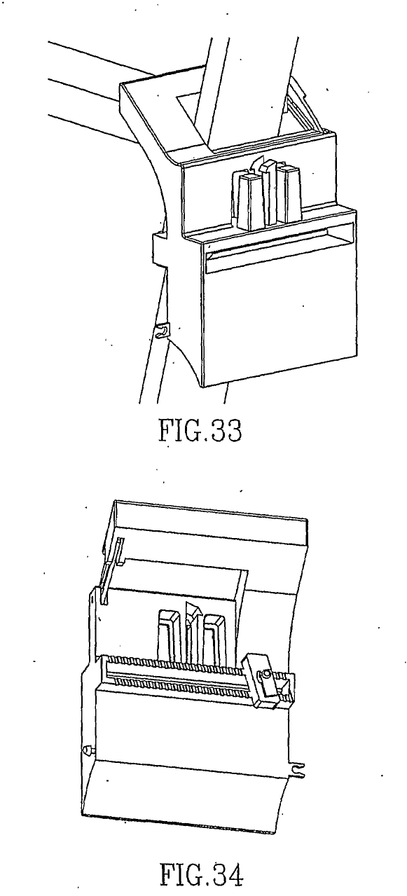

FIG. 33 shows a mount 10, according to an embodiment, mounted on a ladder with the latch 61 closed to secure the mount 10 on the ladder 25. FIG. 34 shows the rear side of the mount of FIG. 33.

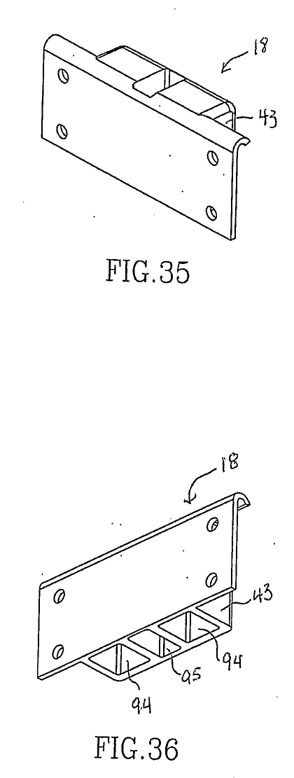

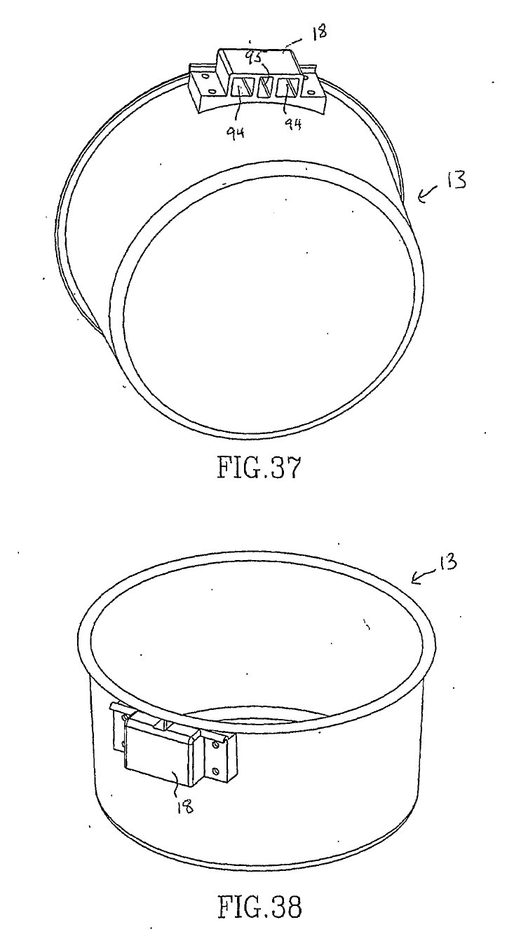

FIGS. 35 and 36 shows an embodiment of a mounting adapter 18 similar to that shown in FIG. 22 and intended for use with a mount 10 having dual posts 32. The channels 94, 95 in the receiver 43 for the posts 32 and catch 85, respectively, are shown in FIG. 36. FIGS. 37 and 38 are views of a round bucket with a mounting adapter 18 attached thereto. FIG. 37 further shows an inverted two-compartment bucket with a mounting adapter attached thereto, and a holder 140.

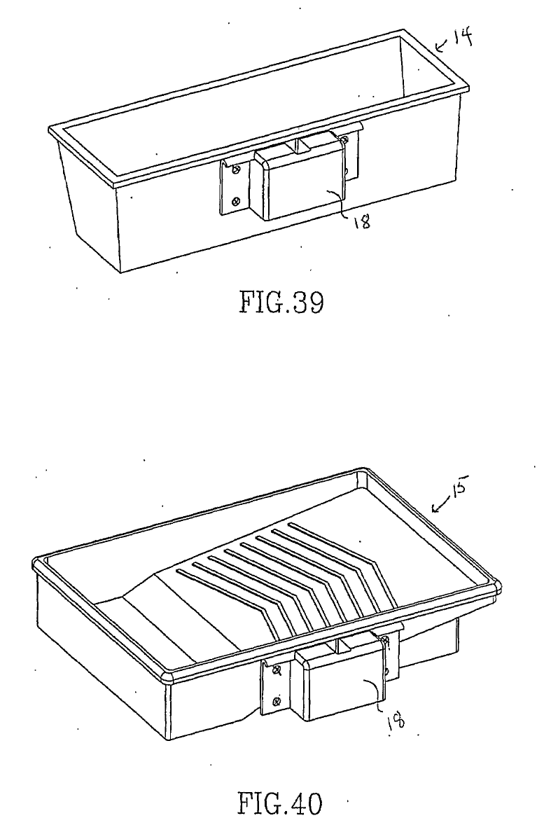

FIG. 39 shows an embodiment of a wallboard tray with a mounting adapter 18 attached thereto. FIG. 40 shows an embodiment of a paint tray with a mounting adapter 18 mounted on the side thereof.

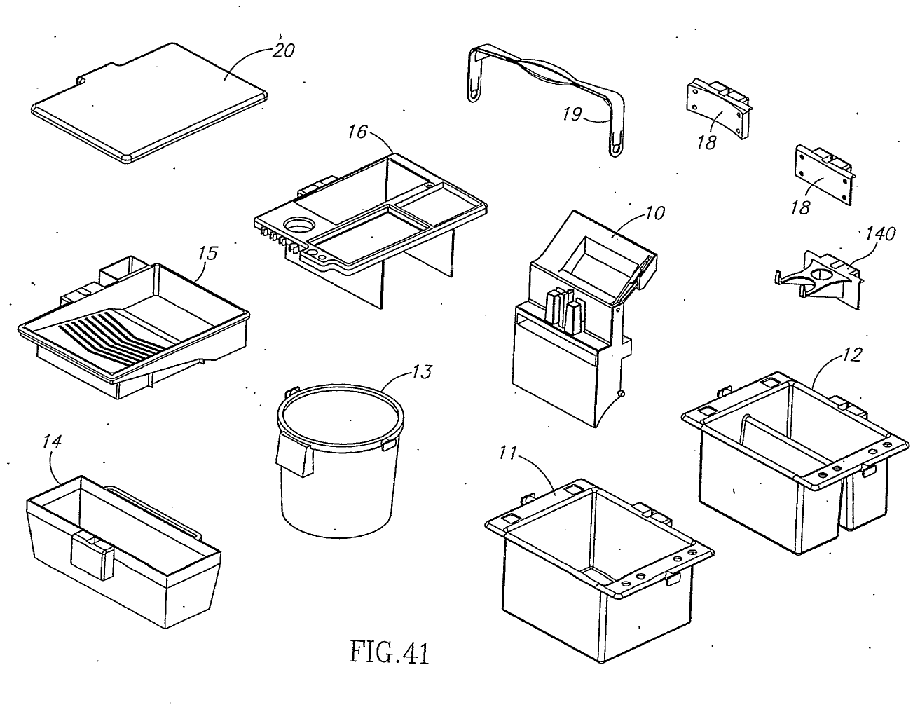

FIG. 41 shows embodiments of a mount 10, mounting adapters 18, bail 19, and a variety of attachments forming a set.

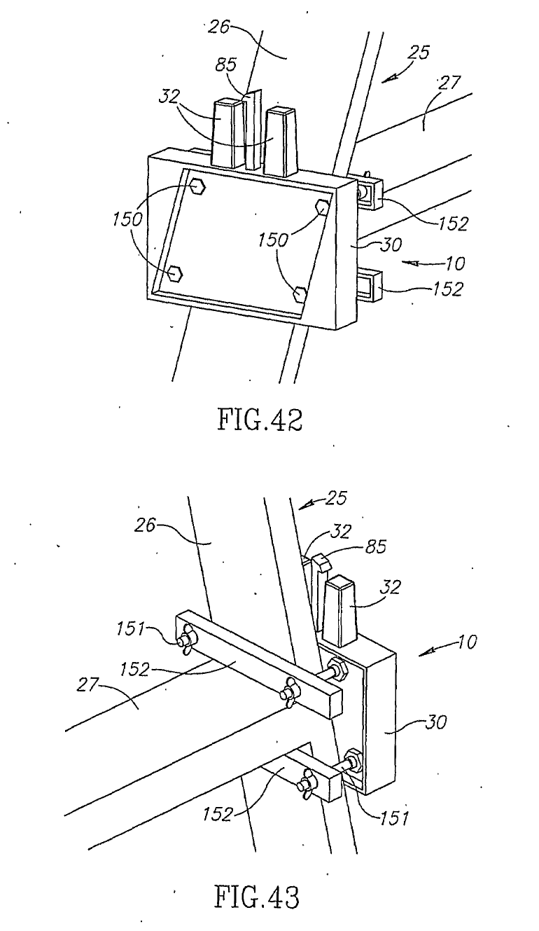

In yet another embodiment, as shown in FIGS. 42 and 43, a mount 10 is provided that may be mounted on the leg 26 of a ladder 25 somewhat more permanently than the mounts 10 that are retained in place by an arm 31, or may be screwed or bolted to a wall, cart, fence, post, vehicle or other structure. As shown in these figures, the mount 10 does not rely on an arm and support for maintaining its position on the ladder 25 or structure. Rather, in the present embodiment, four holes 150 are provided that extend through the body 30 rearward side of this mount 10 through which four bolts 151 (or screws or other fasteners) may be extended. For use with hex-headed bolts, the holes 150 may terminate on the front side of the mount 10 in hex-shaped recesses that can receive the heads of bolts 151 and restrict them from rotation when, for example, wing nuts 152 or other nuts are threaded onto and tightened on the threaded end of the bolts 151.

Where mounting on a ladder 25 is desired, the mount 10 may be placed on the outside of the leg 26 of a ladder 25, and the bolts 151 may be inserted into the holes 150. The mount 10 may be so positioned that the bolts inserted through the upper holes 150 are at a level above a rung 27 of the ladder 25 and the lower holes 150 are below the rung 27. An upper mounting bar 152, having holes adjacent its ends for receiving the bolts 151 extended through the upper holes 150 may be placed on the upper bolts 151 extending through the upper holes 150 of the mount 10 with the upper mounting bar 152 lying immediately above a rung 27 of a ladder 25, and wing nuts or other fasteners may be used to secure the mount 10 and upper mounting bar 152 in place. Similarly, a lower mounting bar 152 may be mounted below the rung 27 by the two lower bolts 151 extending through the lower holes 150 in the mount 10. The mount 10 so attached to the leg 26 of the ladder 25 is restricted from either upward or downward movement along the leg 26 of the ladder 25.

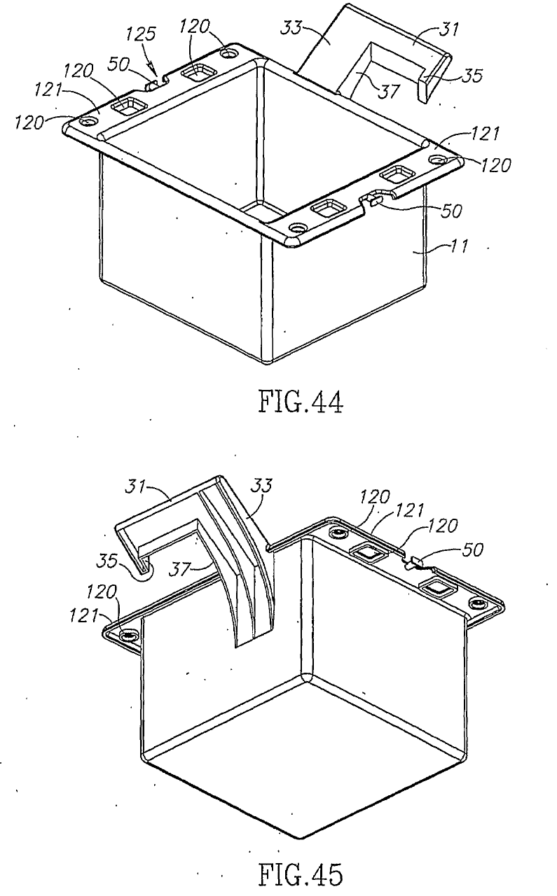

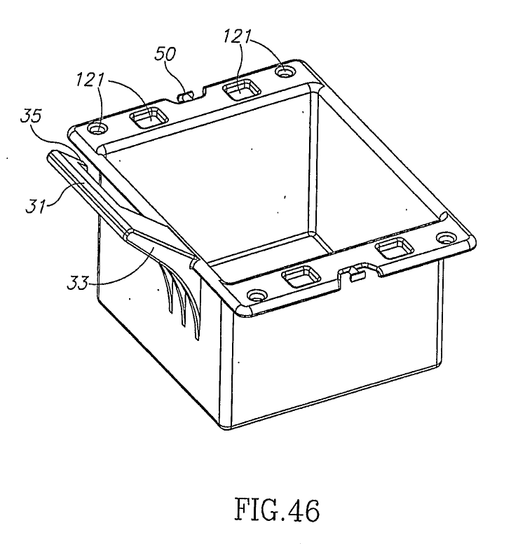

In another embodiment, and as shown in FIGS. 44-46, a rectangular bucket 11 is provided. The bucket 11 does not have a receiver 43 attached to it, but rather has a support 33 from which an arm 31 extends in like manner to the support 33 and arm 31 extending from the various mounts 10 described above. As with the mounts 10, the inner surface 37 of the support may be canted at an angle that approximates the angle at which the front of the leg 26 of a ladder 25 makes with the ground when the ladder 25 is properly positioned for use, which may be about 30 degrees off the vertical. The free end of the arm 31 may include a retaining tab in like manner to the various mounts 11 described above. A latch 61, such as one of the various types discussed above, may be provided with one pivotally mounted end and one demountable end openable and closable between the bucket 11 and tab 35 in like manner to the latches of various of the previously-described mounts. Buckets 11 and other attachments such as the bucket 11 could be provided with studs 111 and/or keepers 114 to which a safety strap 110 could be affixed for further stabilization of the bucket 11.

Lips 121 may protrude from the upper edge of the bucket 11, for example, on opposite sides thereof, in like manner to previous descriptions, and apertures 120 may be formed in the lips 121 for holding tools and other articles the user wishes to insert in them. The apertures 120 may be of different sizes and shapes to hold such articles, such as screw drivers, scrapers, brushes, squeegees, cloths and so forth. In the present embodiment, the lips 121 have channels 125 formed at their centers into which T-studs 50 protrude. As explained above, the T-studs may be used for the mounting of a bail 19 to the bucket 11.

Workers frequently use lifts for performing a variety of tasks. Such lifts may have a worker basket attached to the free end of a hydraulically-positionable arm. The worker may be provided with controls mounted to the basket that permit him or her to raise, lower and otherwise move the basket about. Utility companies are known to use lifts to elevate workers who engage in the trimming of vegetation that might contact power or telephone lines. The baskets frequently have a railing made of intersecting vertical and horizontal tubular members. Railings, guards, carts and other such constructions may also have structures made of such intersecting tubular members.

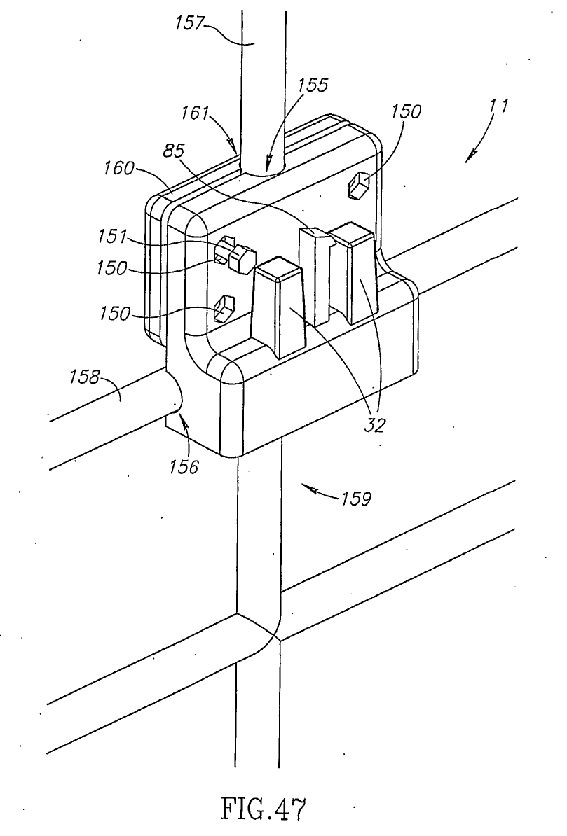

In another embodiment, as shown in FIG. 47, a mount 11 is provided that may be attached to intersecting tubular members such as those found in lift baskets and otherwise. Instead of having an arm 31 and support 33 for mounting the mount 11 on a ladder, 25, the back side of the mount 11 of the present embodiment has vertical and horizontal channels 155, 156 formed therein for receiving the vertical and horizontal tubular members 157, 158 of a railing 159. As with the mount 11 of FIGS. 42, 43, the railing mount 11 of this figure may include a plurality of holes 150 extending horizontally therethrough, and disposed on either side of the vertical channel 155. A back plate 160 with a matching vertical channel 161 (and, optionally, with a matching horizontal channel to that of the mount 11) may be provided with holes 150 in a pattern that matches that of the mount 11. Bolts 151 extending through the holes 150 in the mount and through the corresponding holes in the back plate 160 may be used to hold the mount 11 in place on the railing or other such structure. When used on the railing 159 of a lift basket, the mount 11 may be positioned on the interior or exterior of the railing.

The mount 11 of this embodiment, in like manner to previously-discussed mount 11 embodiments, includes posts 32 disposed on either side of a catch 85 on which the receiver 43 of an attachment may be mounted.

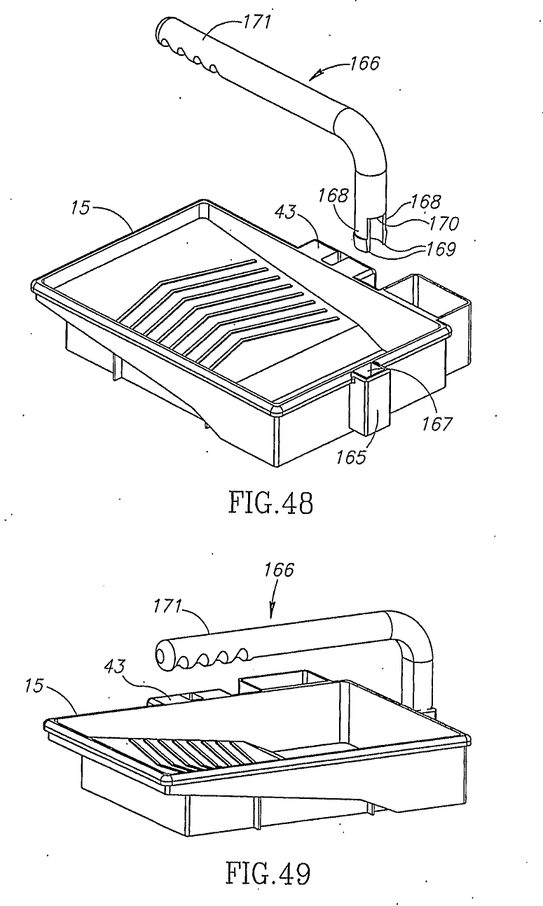

FIGS. 48 and 49 show another embodiment in which an attachment, such as a paint tray 15 is provided with a handle receiver 165 capable of receiving a handle 166. In the present embodiment, a rectangular channel 167 extends vertically through the handle receiver 165 for receiving the mounting arms 168 of the handle 166. The mounting arms 168 of the handle 166 are dimensioned so that they may be extended through the channel 167. The mounting arms 168 are sufficiently resilient that they can be inserted into the rectangular channel 167 of the receiver notwithstanding the catches 169 formed adjacent their free ends.

When the mounting arms 168 of the handle 166 are fully inserted into rectangular channel 167, the catches 169 may protrude from the bottom of the channel 167 and engage the bottom of the handle receiver 165. The handle 166 may be removed from the handle receiver 165 by squeezing the catches 169 together as the handle 166 is pulled upward. The handle 166 includes a shoulder 170 that bears against the top of the handle receiver 165 when the mounting arms 168 of the handle 166 are fully inserted into the rectangular channel 167. A grip 171 is provided at the end of the handle 166 to facilitate carrying of the paint tray 15.

While the handle 166 and handle receiver 165 have been described as mounted on a paint tray, handle receivers could be provided, as desired, on various of the attachments.

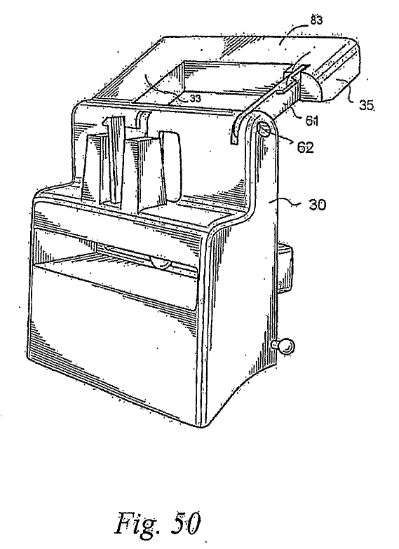

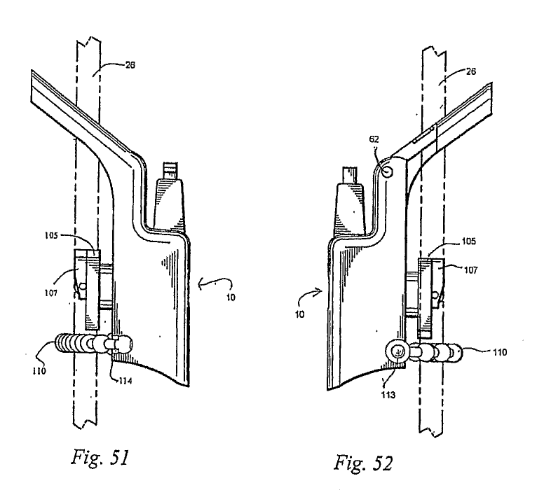

FIG. 50 is directed to another embodiment of a mount 10 in which the latch 61 is mounted at one end to the body 30 of the mount 10 by means of a pin 62. As with other embodiments, the latch 61 is pivotable between closed, or secured positions (as shown) in which it snaps over a pin 62 (not shown) that spans the slot 80 in the distal end of the retainer tab 35, and an open position in which the space between the body 30 and the retainer tab 35 at the distal end of the arm 31 is open to receive the leg 26 of a ladder 25. The latch 61 of this embodiment is not slotted, as in other embodiments.

FIGS. 52 and 53 depict the mount of the embodiment of FIG. 50 with the leg 26 of a ladder 25 shown in phantom with the safety strap 110 secured around the leg 26 of the ladder.

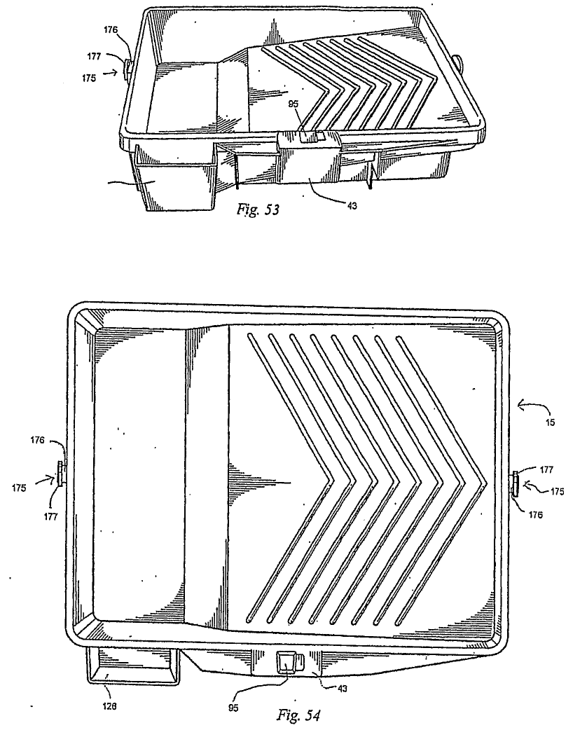

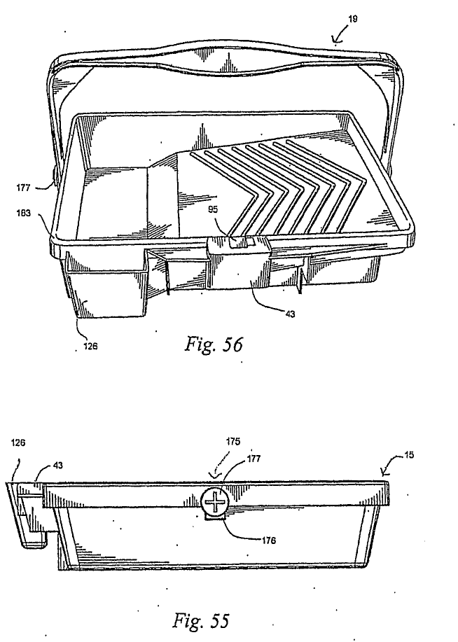

In another embodiment, as shown in FIGS. 54 and 55, a paint tray 15 is provided that is similar in many respects to other embodiments of the paint tray 15, such as the paint tray 15 of FIGS. 48 and 49. As with the paint tray 15 of FIGS. 48 and 49, the present paint tray includes a receiver 43 that includes two channels 94 for receiving the two posts 32 of a mount 10 such as that shown in FIG. 50. Another channel 95 extends upward between the two channels 94 and is open at its upper end so that a portion of the catch 85 can be extended through this open upper end and engage the top surface of the receiver 43 to maintain the receiver 43 in a mounted position on the posts 32. The paint tray 15 further includes a brush cup 126 that may be used to hold brushes, paint or other articles that the user may wish to deposit in it.

Rather than using a handle receiver 165, such as that shown in FIGS. 48 and 49, the present embodiment of the paint tray 15 includes studs 50 protruding from the front and rear of the paint tray. The studs 50 may be molded or otherwise formed integrally with the paint tray 15 of this embodiment, or may be added as by welding, adhesives, fasteners and the like. The shafts 176 of the studs 50 may be of square or rectangular cross section for use with a bail as explained below. The heads 177 of the studs may be round, and may be of greater diameter than the width of the shafts 176 of the studs 50.

With reference to FIGS. 56 and 57, a bail 19 may be provided for use with the paint tray 15 of FIGS. 54 and 55. The bail 19 provides a lifting apparatus for lifting the paint tray 15 and other attachments that are provided with mounts such as the studs 50, and functions in a manner similar to the handle 166 of FIGS. 48 and 49. The bail 19 of this embodiment may be molded of a plastic material. The bail 19 may be fairly rigid by virtue of an I-beam type construction and the use of gussets, as described in connection with the bail 19 of FIG. 30. The holes 133 in the bail 130 that receives the studs 50 of the present embodiment differ from those of FIG. 30. As shown in FIG. 57, the lower portion of the hole 133 is rectangular or square in shape. The dimensions of this portion of the hole 133 correspond to the cross-sectional dimensions of the shaft 176 such that, when the bail 19 is lifted, the lower portion of the hole 133 may engage the shaft 176 of the stud 50 to resist rotation of the paint tray 15 relative to the bail.

The portion of the hole 133 in the bail above the rectangular lower portion may have a circular or semicircular configuration to allow the head 176 of the stud 50 to pass therethrough. The upper portion of the hole 133 may be similar in configuration to the hole 133 of FIG. 30. Channels 134 and a deformable portion 135 may be provided in connection with the upper portion of the hole 133 of FIG. 57 to facilitate the releasable retaining of the bail 19 behind the head 177 of the stud 50.

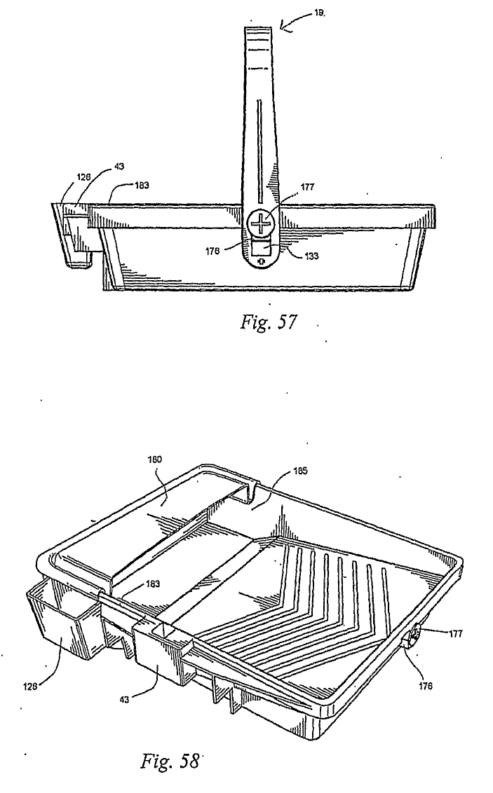

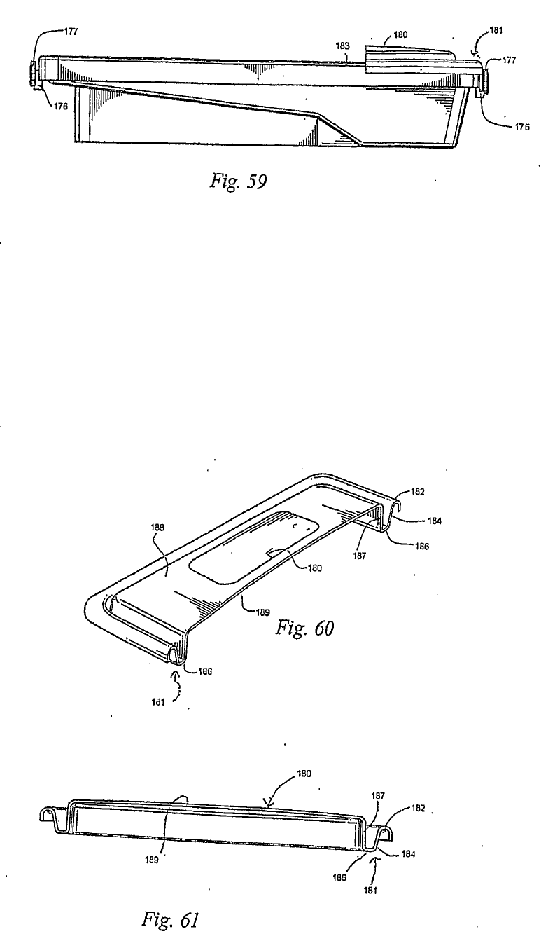

As shown in FIG. 58-61, a partial cap 180 maybe provided for use with a paint tray 15. Such a cap 180 may allow tipping of the paint tray 15 toward its deeper end without leakage of paint out of the paint tray 15, a property that may facilitate carrying of the paint tray 15 without spillage. The cap may be used with the paint tray when a suitable paint tray liner is in place. The cap 180 maybe formed of a resilient material to allow it to flex to a small degree to make a tight fit with the upper lip of the paint tray 15. The resilience may also allow the cap 180 to accommodate any flexure of the paint tray 15 during use or carrying without becoming dislodged or allowing paint to leak or slosh over the end of the paint tray 15.

As best shown in FIGS. 60 and 61, the partial cap 180 is bounded on three sides by a seal section 181 of serpentine cross-section. Proceeding inward from the periphery of the cap, the seal section 181 comprises a lip-engaging portion 182 that fits over and conforms to the peripheral upper edge of a paint tray 15. A descending, generally vertical section 184 descends from the lip-engaging section 182 and engages the adjacent inner wall 185 of the paint tray 15. The descending section 184 may be extended for some length down the inner wall 185 of the paint tray 15 to provide increased sealing of the descending section 184 to the wall 185. The descending section 184 is followed by a U-shaped section 186 that may extend upward to a point above the cover 188 that may form the balance of the cap 180. The cover 188 may be generally planar, but may bow upward somewhat, particularly along the front edge 189 of the cap 180.

The dimensions of the cap 180 and of the serpentine section 181 in particular should be chosen so that they fit snugly on the back portion of the paint tray 15. The resiliency provided by the serpentine section 181 may aid in maintaining a seal along the engaged lip 183 and inner walls 185 of the paint tray 15.

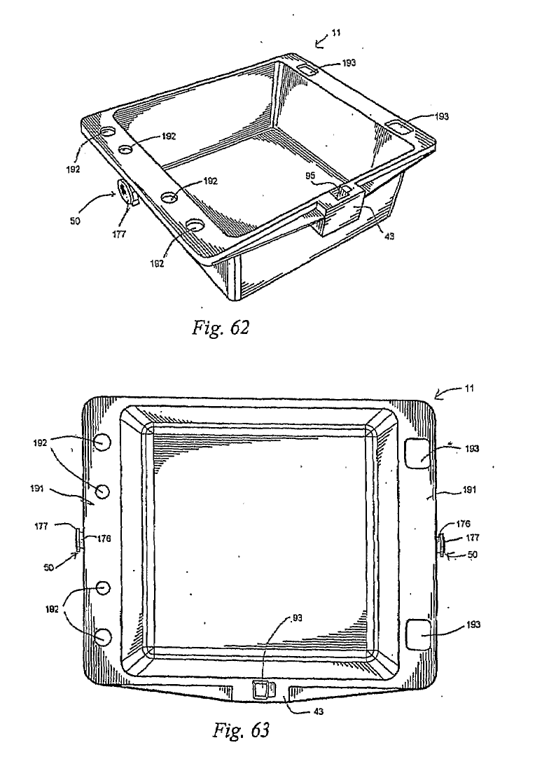

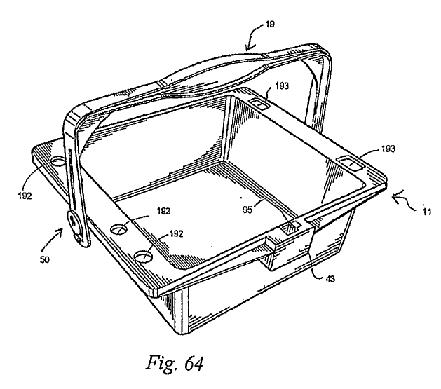

In another embodiment, as shown in FIGS. 62 and 63, a rectangular bucket 11 may include a peripheral lip 191 in which a plurality of round apertures 192 and rectangular apertures 193 are formed. These apertures may be used for holding a variety of articles that may be hung from them including, by way of examples, screwdrivers, brushes, cloths, scrapers, pliers, spray bottles and other tools and articles. Screwdrivers may be inserted into the apertures 192, 193 with their blades down, the handles of brushes may be inserted downward into the apertures, the trigger of spray bottles may be inserted through the apertures so that the bottle hangs off to the side, a cloth or rag may have a portion stuffed into an aperture 192, 193 and so forth.

A receiver is provided at the back side of the bucket 11. In the present embodiment, the receiver is of the type for mounting on a mount 10 such as that shown in FIG. 50, with the catch 85 extending through the aperture 93 to engage the upper surface of the receiver 43. The bucket 11 may be provided with a bail 19 such as that shown in FIG. 57, that may be mounted to the bucket with studs 50 disposed at opposite edges of the bucket 11. The bail 19 may have holes at its ends with a rectangular lower section as discussed in connection with the paint tray and bail 19 depicted in FIG. 57. The shafts 176 of the studs 50 may be of rectangular cross section so that the bail 19 remains erect relative to the bucket 11 when the bucket 11 is carried by the bail 19.

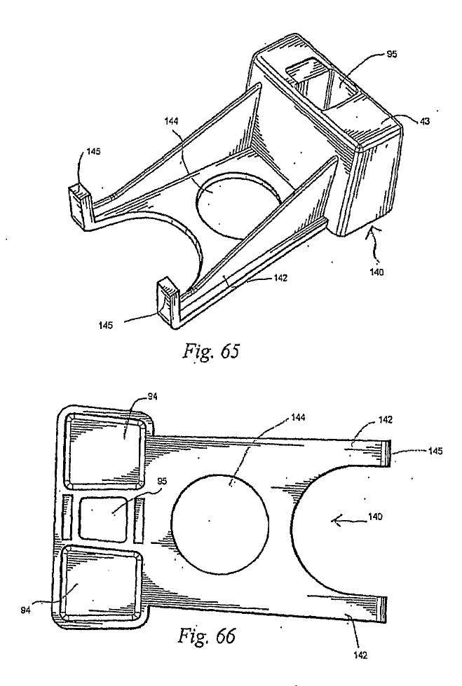

In another embodiment, as shown in FIGS. 65 and 66, a utility holder similar to that of FIG. 32 is provided that includes a receiver 43 with two channels 94 for mounting on a two-post mount 10 such as that depicted in FIG. 50.

Although the present invention has been described in considerable detail with reference to certain preferred embodiments, other embodiments are possible.

1. A mount for use with a ladder comprising:
a mount body having a ladder side and an attachment side;
at least one post connected to the body on the attachment side and upstanding from the body for receiving attachments;
an arm extending behind the ladder side of the mount for supporting the mount body on a ladder and having a surface that faces the body, the arm having a distal end and a support end and a ladder-engaging surface; and
a connector connected to the arm at its support end for connecting the arm to the body, the connector extending away from the ladder side of the mount such that the arm is spaced apart from the body sufficiently for the leg of a ladder to fit between the arm and body, the connector having a ladder-engaging surface.

2. The mount of claim 1 wherein the ladder-engaging surface is angled such that, when the mount is mounted on a ladder with the leg of the ladder between the arm and body, the angle of the inner surface of the leg corresponds to the angle from vertical of the front surface of the ladder leg.

3. The mount of claim 1 wherein the body-facing surface of the arm is angled such that, when the mount is mounted on a ladder with the leg of the ladder between the arm and body, the angle of the surface of the arm corresponds to the angle from vertical of the inner surface of the ladder leg.

4. The mount of claim 1 wherein a latch is pivotably attached to the mount such that it may be moved from a first, latching position in which it spans the gap between the distal end of the arm and the body of the mount, and a second, open position in which a ladder may be inserted past the distal end of the arm into the gap between the arm and the body of the mount.

5. The mount of claim 1 further comprising at least one stabilizer extending rearward from the ladder-engaging surface of the mount for engaging at least one of the front and rear surfaces of a ladder leg inserted between the arm and the body of the mount.

6. The mount of claim 5 wherein the ladder-engaging surface of the mount comprises a plurality of slots and wherein the at least one stabilizer comprises a peg insertable into a slot in the ladder-engaging surface of the body of the mount.

7. The mount of claim 5 wherein the at least one stabilizer comprises a block adjustably fastenable to the ladder-engaging surface of the body of the mount.

8. The mount of claim 7 wherein the stabilizer comprises a ladder-engaging surface for contacting the front surface of the leg of a ladder, the ladder-engaging surface being positionable such that it is angled relative to the mount at an angle that corresponds to the angle of the front surface of a leg of a ladder that is inserted between the arm and body of the mount.

9. The mount of claim 1 further comprising a safety strap mountable to the mount by first and second keepers such that the safety strap may be extended behind the inner surface of the leg of a ladder positioned between the arm and body of the mount for resisting dislodgement of the mount from the ladder.

10. A mount comprising:
a body mountable in contact with a ladder and having front and rear surfaces;
an arm having a support end and a distal end;
a support for supporting the arm at a distance from the rear surface of the body such that a channel exists between the arm and body; and
a retainer connected to the distal end of the arm and extending toward the body for resisting movement of a ladder leg.

11. The mount of claim 10 wherein the retainer comprises a projection mounted on the arm and having a distal arm extending toward the body, the distal end of the retainer and the body having a gap between them sufficient to allow the leg of a ladder to be positioned between the arm and the body of the mount.

12. The mount of claim 10 wherein the retainer comprises a latch releasably connectable between the arm and body of the mount.

13. The mount of claim 10 further comprising a utility attachment support.

14. The mount of claim 13 wherein the utility attachment support comprises a band into which the utility attachment may be inserted, the band and the attachment having dimensions such that, when the band is maintained in a horizontal orientation, the attachment may be inserted from the top of the band and be retained by the band.

15. The mount of claim 13 wherein the attachment support further comprises at least one post carried by the body and extending upward to a distal end.

16. The mount of claim 15 further comprising a catch carried by the body and spaced from the at least one post and extending upward, the catch being spaced apart from the post.

17. The mount of claim 16 wherein the at least one post comprises two posts extending upward in parallel.

18. The mount of claim 17 wherein the catch extends upward between the two posts. where the at least one post.

19. The mount of claim 10 further comprising at least one stabilizer extending rearward from the ladder-engaging surface of the mount for engaging at least one of the front and rear surfaces of a ladder leg inserted between the arm and the body of the mount.

20. The mount of claim 10 further comprising a safety strap mountable to the mount by first and second keepers such that the safety strap may be extended behind the inner surface of the leg of a ladder positioned between the arm and body of the mount for resisting dislodgement of the mount from the ladder.

21. A receiver for mounting a utility attachment to a mount wherein the mount comprises at least one post, the receiver having a body with upper and lower surfaces and comprising;
a channel extending upward through the body and terminating below the upper surface of the body for receiving the post of a mount having at least one post, the channel having dimensions corresponding to the dimensions of the mount;
a mounting section connected to the body of the receiver for attachment to a utility attachment.

22. The receiver of claim 21 wherein the at least one post comprises two posts and wherein the receiver comprises two channels extending upward in parallel through the body.

23. The receiver of claim 22 further comprising a channel extending upward through the body between the post-receiving channels for receiving a catch extending upward from a mount for releasably securing the receiver in position on a mount.

24. A system for mounting an attachment on a support comprising:
a mount, the mount comprising:
a body mountable in contact with a ladder and having front and rear surfaces;
an arm having a support end and a distal end;
a support for supporting the arm at a distance from the rear surface of the body such that a channel exists between the arm and body; and
a utility attachment support for supporting a utility attachment; and
a utility attachment, the utility attachment comprising an article with at least one edge, the utility attachment further comprising a receiver for receiving and being supported by the at least one post.

25. The system of claim 24 wherein the attachment support further comprises at least one post carried by the body and extending upward to a distal end.

26. The system of claim 25 further comprising a catch carried by the body and spaced from the at least one post and extending upward, the catch being spaced apart from the post.

27. The system of claim 26 wherein the at least one post comprises two posts extending upward in parallel.

28. The system of claim 27 wherein the catch extends upward between the two posts. where the at least one post.

29. The system of claim 25 further comprising at least one stabilizer extending rearward from the ladder-engaging surface of the mount for engaging at least one of the front and rear surfaces of a ladder leg inserted between the arm and the body of the mount.

30. The system of claim 29 wherein the at least one stabilizer comprises a block adjustably fastenable to the ladder-engaging surface of the body of the mount.

31. The system of claim 25 wherein a channel having dimensions corresponding to the dimensions of the post extends upward into the receiver for receiving the post.

32. A utility attachment for mounting on a mount wherein the mount comprises at least one upstanding post, the utility attachment comprising:
a receiver, the receiver having a body with upper and lower surfaces and comprising;
a channel extending upward through the lower surface and body and terminating below the upper surface of the body for receiving the post of a mount having at least one post, the channel having dimensions corresponding to the dimensions of the mount; and
a utility article.

33. The utility attachment of claim 32 wherein the utility article is selected from the group consisting of a round bucket, a rectangular bucket, a double bucket, a drywall pan, a paint tray, a work tray, a tool holder and a paint and work tray.

34. The utility attachment of claim 32 wherein the utility attachment comprises a tool holder comprising at least two arms extending outward from the receiver and forming a “U”-shaped channel between them, the ends of the arms being upturned; and
an aperture of diameter sufficient to admit a garden hose therethrough formed between the “U”-shaped channel and the receiver.

35. The utility attachment of claim 32 wherein the utility article comprises a paint tray having front and back ends, and wherein the paint tray comprises an upstanding wall about its periphery, the paint tray further comprising studs mounted to the upstanding wall adjacent the center of the front and rear ends thereof, the studs each comprising a shaft mounted on the wall and terminating in a head having a greater width than the shaft for receiving respective ends of a bail.

36. The utility attachment of claim 32 comprising first and second studs mounted on opposite sides of the utility article adjacent the periphery thereof, the studs each comprising a shaft extending outward from the utility article and a head adjacent the free end of the shaft, the head being greater in cross-section than the shaft.

37. The utility attachment of claim 36 wherein the shaft is rectangular in cross-section and wherein the utility article further comprises a bail, the bail having apertures adjacent first and second ends thereof, and the apertures having upper and lower portions, the lower portion being proximate the adjacent end of the bail and having a rectangular section, the lower, rectangular section being of dimensions consistent with the shaft such that, when the bail is raised relative to the studs, the rectangular shafts engage the rectangular portions of the apertures, whereby rotation of the bail relative to the shafts is restricted.

38. A paint tray cap for restricting leaks from one end of a paint tray having a lip about said periphery and walls descending from the lip, the paint tray cap comprising:
a section of serpentine cross-section extending around at least three sides of the cover, the serpentine section comprising a first, lip engaging portion for engaging the interior and exterior sides of the lip, a descending portion positionable within the paint tray when the lip-engaging portion is mounted on the lip and formed to engage the inner wall of the paint tray, a U-shaped portion attached to the lower edge of the descending section, and an ascending portion that rises to a level at least as high as the lip of the paint tray; and
a cover section attached to the ascending portion of the serpentine section.
